(19) United States
(12) Patent Application Publication
(10) Pub. No.: US 2025/0024305 A1
(43) Pub. Date: Jan. 16, 2025

(54) POSITIONING HANDOVERS FOR MOBILE USER EQUIPMENT

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/710,309

(22) PCT Filed: Sep. 29, 2022
(86) PCT No.: PCT/US2022/077250

§ 371 Date: May 15, 2024

(30) Foreign Application Priority Data
Dec. 1, 2021 (GR) 20210100836

(51) Int. Cl. H04W 28/02; G01S 13/74; G01S 19/48; H04W 56/00

(52) U.S. Cl. CPC H04W 28/0226; G01S 13/74; H04W 56/001; G01S 19/48

(57) ABSTRACT

A method of wireless communication performed by a user equipment (UE) is disclosed and includes determining a position of the UE based on a first positioning synchronization source; pre-configuring a first sidelink coordination group for use by the UE prior to an occurrence of one or more first triggering events, wherein the first sidelink coordination group uses a second positioning synchronization source that is different than the first positioning synchronization source; and in response to a determination that the one or more first triggering events has occurred, transitioning to use of the first sidelink coordination group for determining the position of the UE.

### CROSS-REFERENCE TO RELATED APPLICATIONS

The present application for patent claims the benefit of GR application No. 20210100836, entitled “POSITIONING HANDOVERS FOR MOBILE USER EQUIPMENT”, filed Dec. 1, 2021, and is a national stage application, filed under 35 U.S.C. § 371, of International Patent Application No. PCT/US2022/077250, entitled, “POSITIONING HANDOVERS FOR MOBILE USER EQUIPMENT”, filed Sep. 29, 2022, both of which are assigned to the assignee hereof and are expressly incorporated herein by reference in their entirety.

### BACKGROUND OF THE DISCLOSURE

### Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data. Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes determining a position of the UE based on a first positioning synchronization source; pre-configuring a first sidelink coordination group for use by the UE prior to an occurrence of one or more first triggering events, wherein the first sidelink coordination group uses a second positioning synchronization source that is different than the first positioning synchronization source; and in response to a determination that the one or more first triggering events has occurred, transitioning to use of the first sidelink coordination group for determining the position of the UE.

In an aspect, a method of wireless communication performed by a location server includes receiving, from a user equipment (UE), an indication of one or more preferred sidelink devices with which the UE can communicate; and sending, to the UE, an indication of one or more sidelink coordination groups for positioning pre-configuration by the UE, wherein the one or more sidelink coordination groups include at least one of the one or more preferred sidelink devices.

In an aspect, a user equipment (UE) includes a memory; at least one transceiver; and at least one processor communicatively coupled to the memory and the at least one transceiver, the at least one processor configured to: determine a position of the UE based on a first positioning synchronization source; pre-configure a first sidelink coordination group for use by the UE prior to an occurrence of one or more first triggering events, wherein the first sidelink coordination group uses a second positioning synchronization source that is different than the first positioning synchronization source; and in response to a determination that the one or more first triggering events has occurred, transitioning to use of the first sidelink coordination group for determining the position of the UE.

In an aspect, a location server includes a memory; at least one transceiver; and at least one processor communicatively coupled to the memory and the at least one transceiver, the at least one processor configured to: receive, via the at least one transceiver, from a user equipment (UE), an indication of one or more preferred sidelink devices with which the UE can communicate; and send, via the at least one transceiver, to the UE, an indication of one or more sidelink coordination groups for positioning pre-configuration by the UE, wherein the one or more sidelink coordination groups include at least one of the one or more preferred sidelink devices.

In an aspect, a user equipment (UE) includes means for determining a position of the UE based on a first positioning synchronization source; means for pre-configuring a first sidelink coordination group for use by the UE prior to an occurrence of one or more first triggering events, wherein the first sidelink coordination group uses a second positioning synchronization source that is different than the first positioning synchronization source; and means for transitioning to use of the first sidelink coordination group for determining the position of the UE in response to the occurrence of the one or more first triggering events.

In an aspect, a location server includes means for receiving, from a user equipment (UE), an indication of one or more preferred sidelink devices with which the UE can communicate; and means for sending, to the UE, an indication of one or more sidelink coordination groups for positioning pre-configuration by the UE, wherein the one or more sidelink coordination groups include at least one of the one or more preferred sidelink devices.

In an aspect, a non-transitory computer-readable medium storing computer-executable instructions that, when executed by a user equipment (UE), cause the UE to: determine a position of the UE based on a first positioning synchronization source; pre-configure a first sidelink coordination group for use by the UE prior to an occurrence of one or more first triggering events, wherein the first sidelink coordination group uses a second positioning synchronization source that is different than the first positioning synchronization source; and transition to use of the first sidelink coordination group for determining the position of the UE in response to the occurrence of the one or more first triggering events.

In an aspect, a non-transitory computer-readable medium storing computer-executable instructions that, when executed by a location server, cause the location server to: receive, from a user equipment (UE), an indication of one or more preferred sidelink devices with which the UE can communicate; and send, to the UE, an indication of one or more sidelink coordination groups for positioning pre-configuration by the UE, wherein the one or more sidelink coordination groups include at least one of the one or more preferred sidelink devices.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system according to aspects of the disclosure.

FIGS. 2A and 2B illustrate example wireless network structures according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure according to aspects of the disclosure.

FIG. 5 illustrates basic sidelink transmission scenarios according to aspects of the disclosure.

FIG. 6 shows example sidelink deployment scenarios according to aspects of the disclosure.

FIG. 7 shows an example resource pool according to aspects of the disclosure.

FIG. 8 depicts an example configuration of symbols for a slot of a sub-channel according to aspects of the disclosure.

FIG. 9 is a timing diagram showing an example of Mode 2 resource allocation according to aspects of the disclosure.

FIG. 10 illustrates an example of a wireless communications system that supports unicast sidelink establishment, according to aspects of the disclosure.

FIG. 11 illustrates an example wireless communication system in which a vehicle user equipment (V-UE) is exchanging ranging signals with a roadside unit (RSU) and another V-UE, according to aspects of the disclosure.

FIG. 12 is a timeline illustrating a three-phase communication protocol used for sidelink ranging signals, according to aspects of the disclosure.

FIG. 13 is a diagram illustrating an example sidelink ranging and positioning procedure, according to aspects of the disclosure.

FIG. 14 to FIG. 19 show example scenarios as multiple V-UEs pass through a tunnel according to aspects of the disclosure.

FIG. 20 shows an example method of wireless communication that may be performed by a user equipment (UE) according to aspects of the disclosure.

FIG. 21 shows an example method of wireless communication that may be performed by a location server according to the aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device.” an “access terminal” or “AT.” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

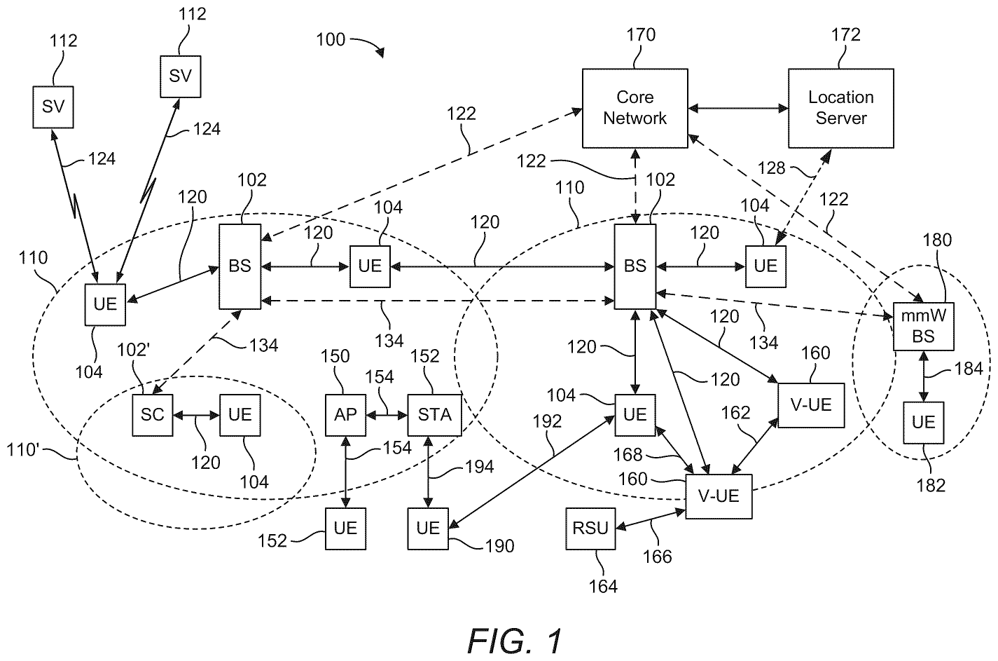

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g. through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mm W and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell.” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHZ. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe. IEEE 802.11p operates in the ITS GSA band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems. FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

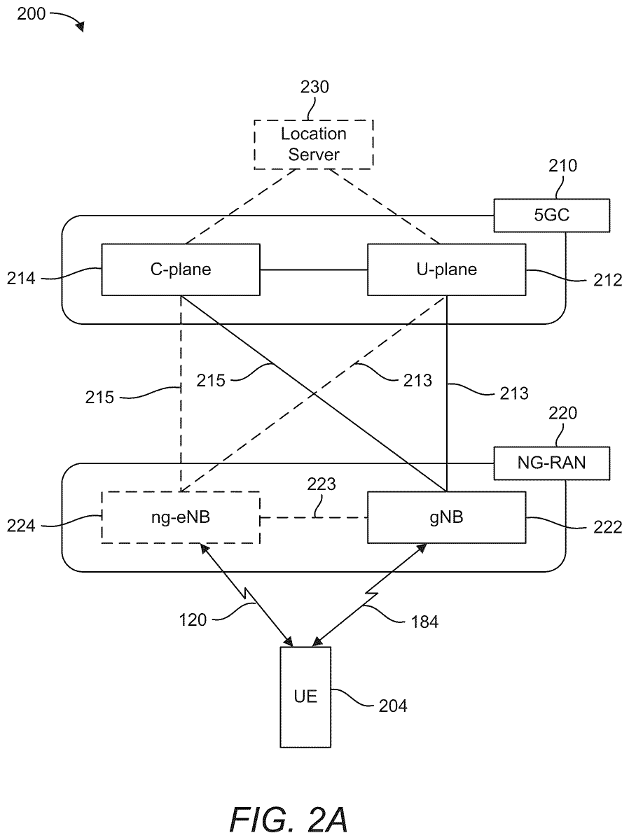

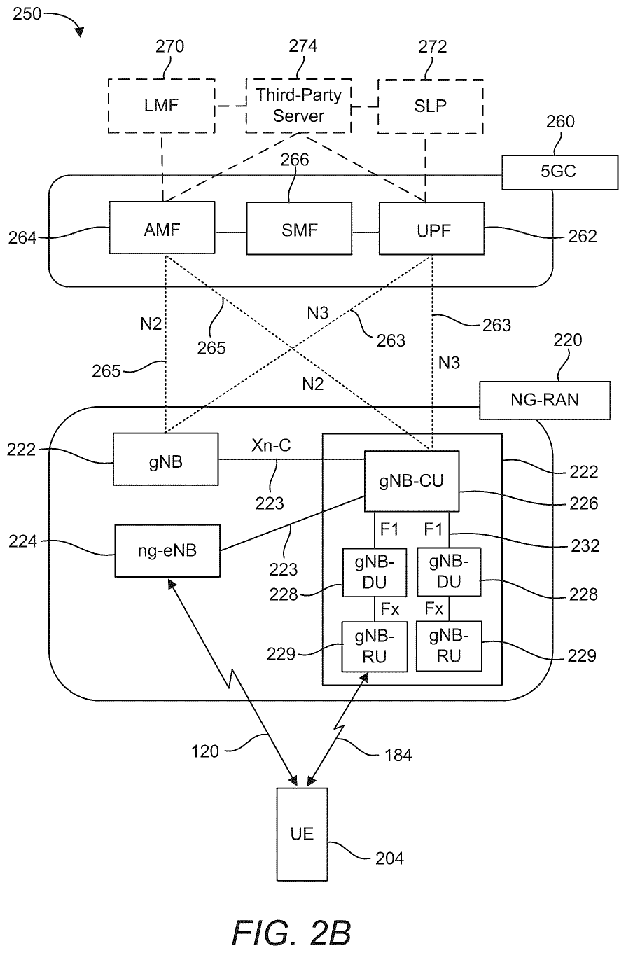

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-cNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-cNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-cNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

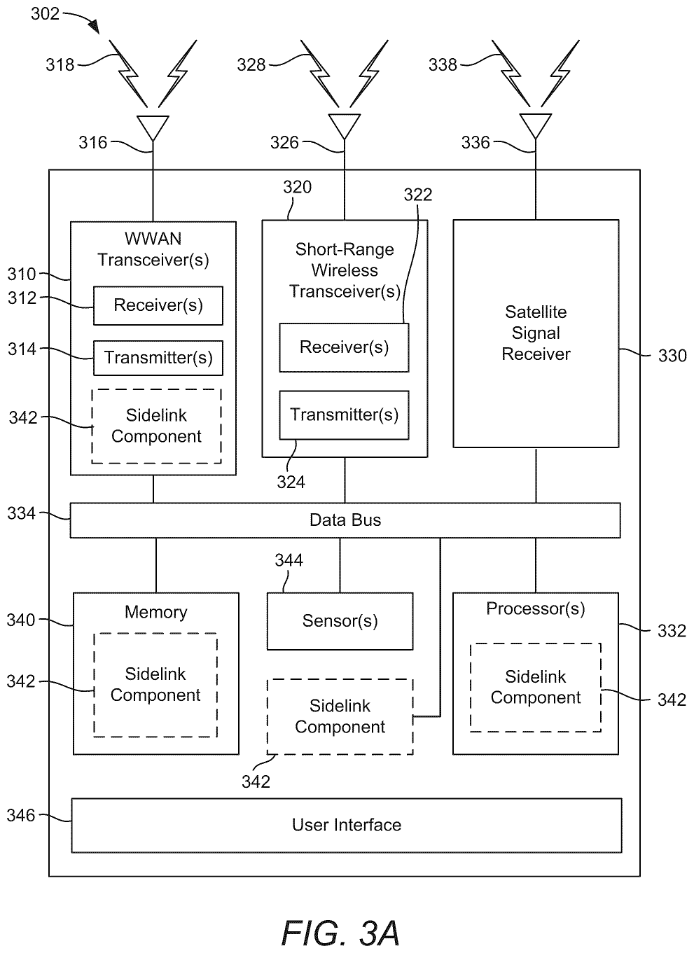

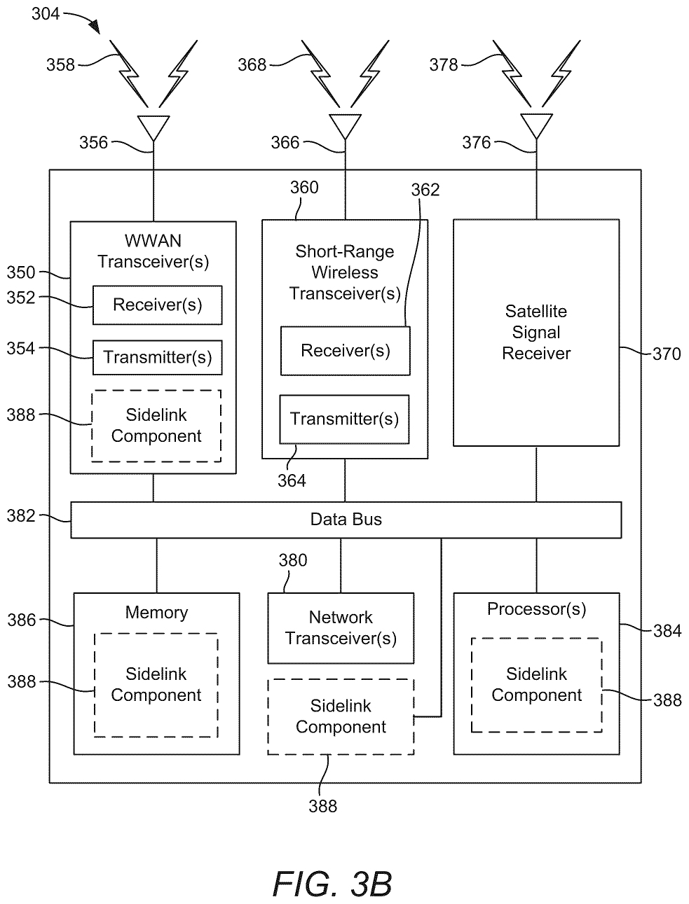

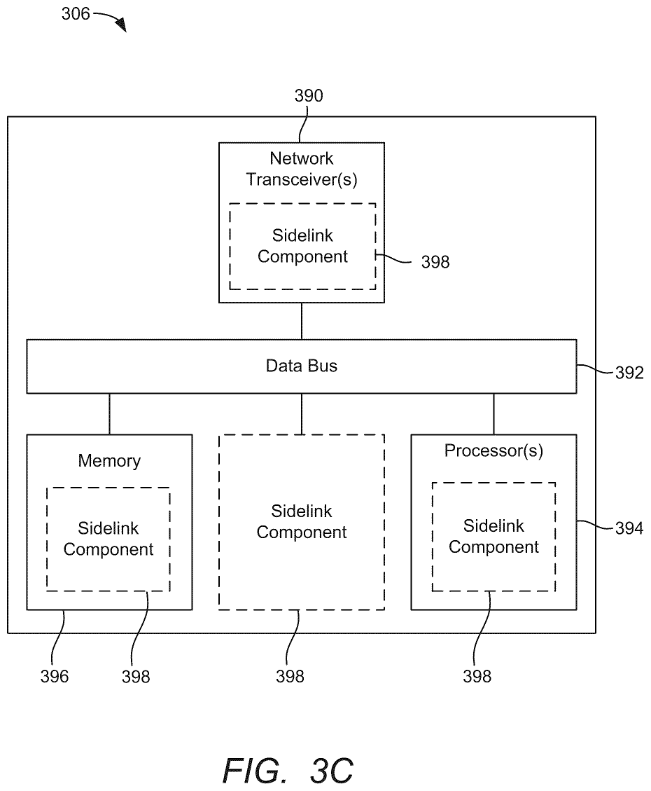

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., cNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers. Zigbee and/or Z-Wave transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming.” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include sidelink component 342, 388, and 398, respectively. The sidelink component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the sidelink component 342, 388, and 398 may be external to the processors 332, 384, and 394 (e.g., part of a modem processing system, integrated with another processing system, etc.). Alternatively, the sidelink component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the sidelink component 342, which may be, for example, part of the one or more WWAN transceivers 310, the memory 340, the one or more processors 332, or any combination thereof, or may be a standalone component. FIG. 3B illustrates possible locations of the sidelink component 388, which may be, for example, part of the one or more WWAN transceivers 350, the memory 386, the one or more processors 384, or any combination thereof, or may be a standalone component. FIG. 3C illustrates possible locations of the sidelink component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE.” “by a base station.” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the sidelink component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

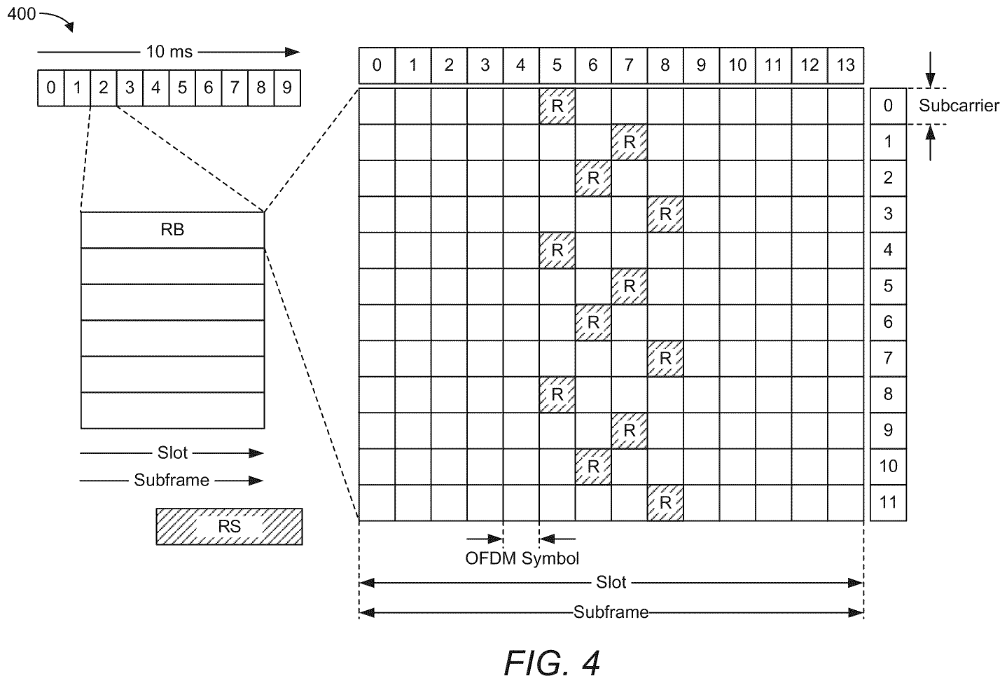

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Such frame structures are also used in sidelink communications between UEs. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (u), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe. 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 KHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 KHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

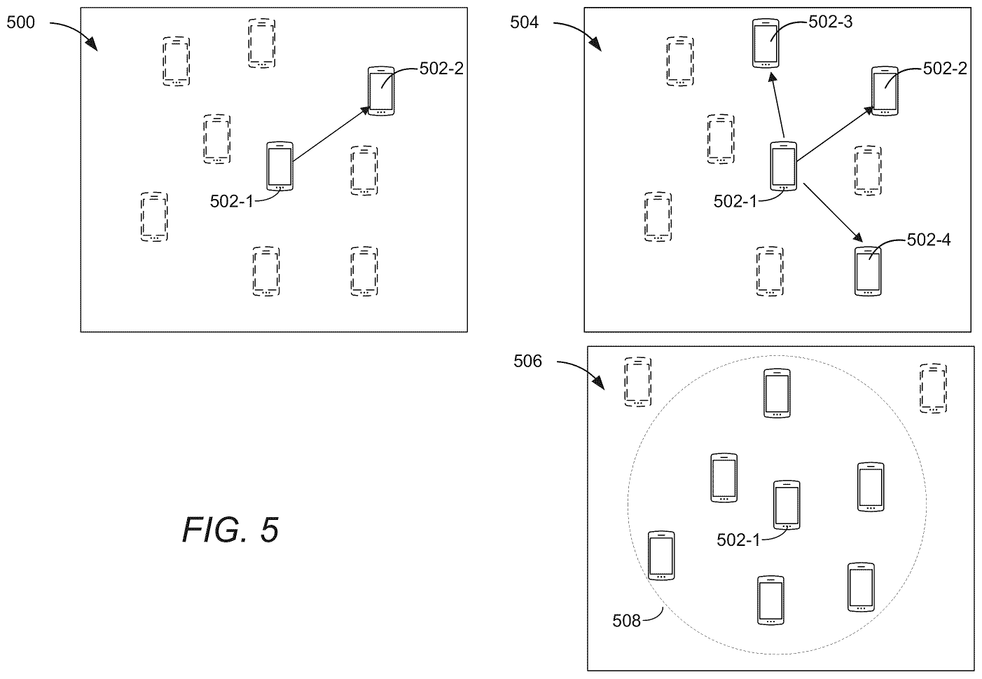

NR sidelink supports several basic transmission scenarios, including 1) unicast, in which case the sidelink transmission targets a specific receiving device, 2) groupcast, in which case the sidelink transmission targets a specific group of receiving devices, and 3) broadcast, in which case the sidelink transmission targets any device that is within the range of the transmission. FIG. 5 illustrates the basic transmission scenarios in accordance with certain aspects of the disclosure. Transmission scenario 500 shows a unicast scenario in which UE 502-1 has targeted UE 502-2 for communication to the exclusion of other UEs in the environment. Transmission scenario 504 shows a group cast a scenario in which UE 502-1 has targeted UE 502-2, UE 502-3, and UE 502-4 for targeted communications. Transmission scenario 506 shows a broadcast scenario in which all UEs within the transmission range 508 of UE 502-1 are targeted for transmission.

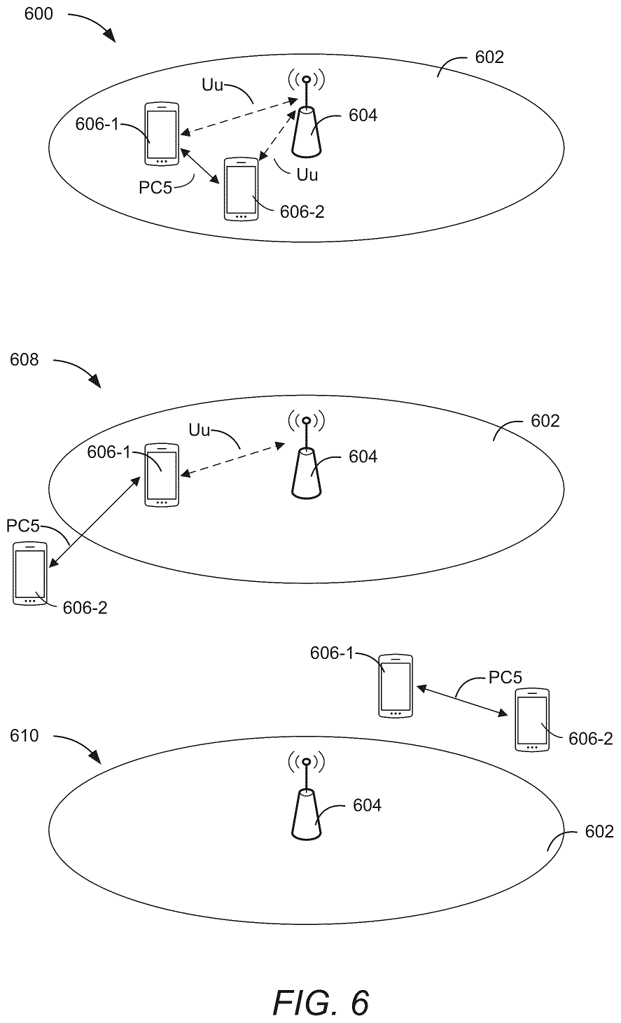

Generally, there are three deployment scenarios for NR sidelink communication in terms of the relation between the sidelink communication and an overlaid cellular network. FIG. 6 shows three such deployment scenarios in accordance with certain aspects of the disclosure. Deployment scenario 600 shows an in-coverage scenario in which both UE 606-1 and UE 606-2 are within the coverage 602 of a base station 604 and communicate with the base station 604 via Uu links. In deployment scenario 600, the UEs 606-1 and 606-2 communicate with one another via a PC5 link. To a smaller or larger extent, depending on the exact mode of operation of the UEs 606-1 and 606-2, the base station 604 may control the sidelink communications. Deployment scenario 608 shows a partial coverage scenario in which UE 606-1 is within coverage 602 and communicates with the base station 604 over a Uu link. In deployment scenario 608, the UEs 606-1 and 606-2 are within the communication range of one another and communicate via a PC5 link. In an aspect, UE 606-1 may act as a relay for communications between the base station 604 and UE 606-2. Deployment scenario 610 shows the out-of-coverage operation in which neither UE 606-1 nor UE 606-2 are within coverage 602 but are nevertheless within communication range of one another over a PC5 link.

Similar to downlink and uplink transmissions that take place over a Uu link, sidelink transmissions take place over a set of physical channels on to which a transport channel is mapped and/or which carry different types of L1/L2 control signaling. The physical channels include 1) a physical sidelink shared channel (PSSCH), 2) a physical sidelink control channel (PSCCH), 3) a physical sidelink broadcast channel (PSBCH), and 4) the physical sidelink feedback channel (PSFCH). The PSCCH carries control information in the sidelink. The PSSCH carries a data payload in the sidelink and additional control information. The PSBCH carries information for supporting synchronization in the sidelink. PSBCH is sent within a sidelink synchronization signal block (S-SSB). The PSFCH carries feedback related to the successful or failed reception of a sidelink transmission.

Furthermore, NR sidelink communications support various signals, including reference signals, that are carried in or associated with the physical channels. In this regard, a DMRS is used by a sidelink receiver for decoding the associated sidelink physical channel, i.e., PSCCH, PSSCH, PSBCH. The DMRS is sent within the associated sidelink physical channel. A sidelink primary synchronization signal (S-PSS) and sidelink secondary synchronization signal (S-SSS) may be used by a sidelink receiver to synchronize to the transmitter of these signals. S-PSS and S-SSS are sent within the S-SSB. Sidelink (SL) Channel state information reference signals (SL CSI-RS) are used for measuring channel state information (CSI) at the receiver that is then fed back to the transmitter. The transmitter adjusts its transmission based on the fed-back CSI. SL CSI-RS is sent within the PSSCH region of the slot. Sidelink Phase-tracking reference signals (SL PT-RS) are used for mitigating the effect of phase noise (in particular at higher frequencies) resulting from imperfections of the oscillator. SL PT-RS is sent within the PSSCH region of the slot. Sidelink positioning reference signals (S-PRS) are used to conduct positioning operations to determine the absolute position of a sidelink device and/or the relative position of a sidelink device with respect to other sidelink devices. The S-PRS is sent within the PSSCH region of the slot.

In NR, only certain time and frequency resources are (pre-) configured to accommodate SL transmissions. The subset of the available SL resources is (pre-) configured to be used by several UEs for their SL transmissions. This subset of available SL resources is referred to as a resource pool.

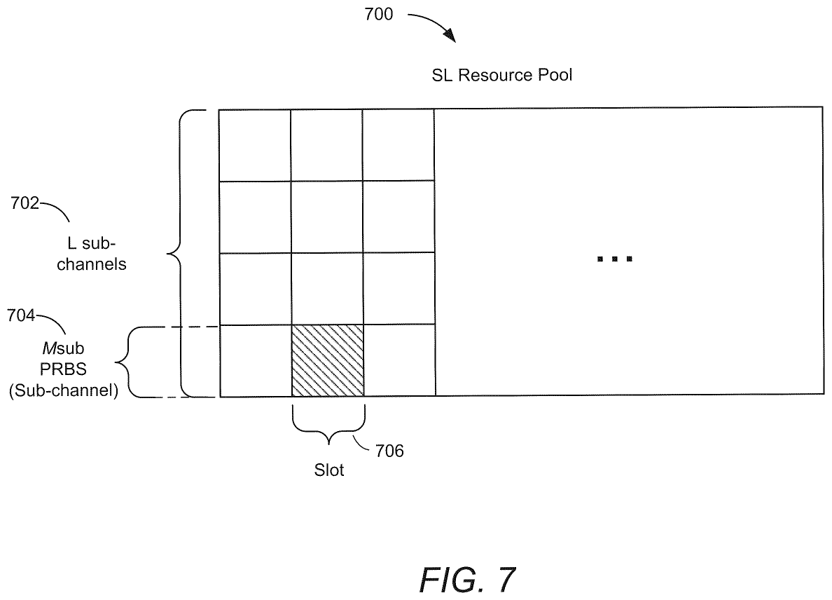

FIG. 7 shows an example SL resource pool 700 in accordance with certain aspects of the disclosure. A resource pool consists of contiguous PRBs and contiguous or non-contiguous slots that have been (pre-) configured for SL transmissions. In the frequency domain, a resource pool is divided into a (pre-) configured number L of contiguous sub-channels 702, where a sub-channel 704 consists of a group of consecutive PRBs in a slot 706. The number Msub of PRBs in a sub-channel corresponds to the sub-channel size, which is (pre-) configured within the resource pool 700. In an aspect, the sub-channel size Msub can be equal to 10, 12, 15, 20, 25, 50, 75, or 100 PRBs. A sub-channel represents the smallest frequency domain unit for a sidelink data transmission or reception. A sidelink transmission can use one or multiple sub-channels. In the time domain, the slots that are part of a resource pool are (pre-) configured and occur on a periodic basis. In the example of FIG. 7, sidelink resources are shown as individual resource pool elements, where each resource element consists of a single slot 706 over a set of common physical resource blocks (PRBs) of a sub-channel 704.

In an aspect, the slot 706 of a sub-channel only allocates a subset of its consecutive symbols (pre-) configured for sidelink communications. The subset of SL symbols per slot is indicated with a starting symbol and a number of consecutive symbols, where these two parameters are (pre-) configured per the resource pool. The number of consecutive SL symbols can vary between 7 and 14 symbols depending on the physical channels which are carried within a slot.

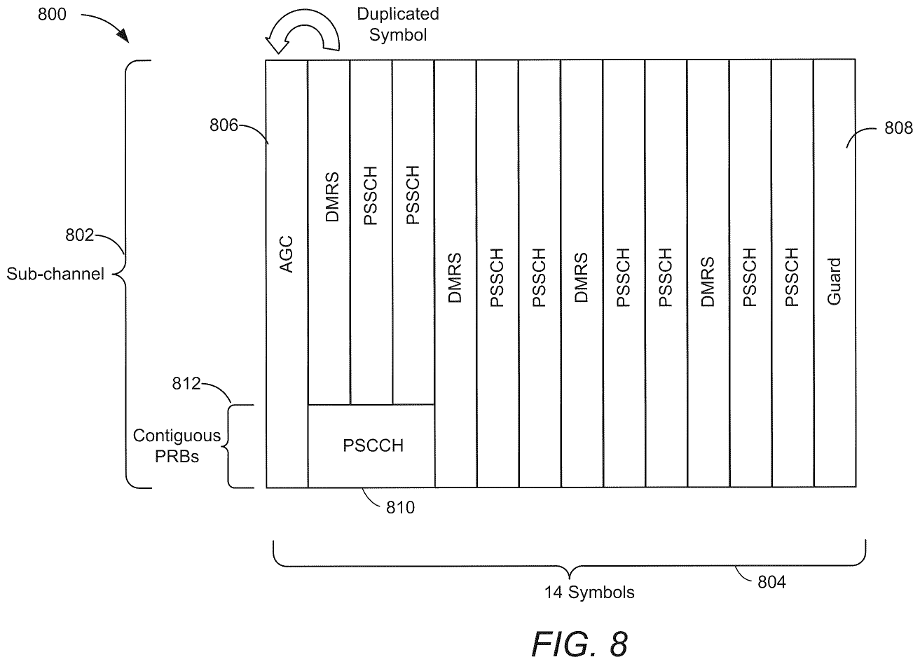

FIG. 8 depicts an example configuration of symbols of a sidelink resource 800 for a slot of a sub-channel in accordance with certain aspects of the disclosure. In this example, the configuration is directed to a single sub-channel 802 and a single slot 804. Here, slot 804 is 14 symbols in length, and includes 3 PSCCH symbols and 8 PSSCH symbols. The example slot 804 includes 4 DMRS symbols which are carried in the PSSCH symbols. Among other data, the PSSCH carries the 1st-stage-SCI as discussed in further detail herein. The first symbol carried by each PRB of the SL resource 800 is an automatic gain control (AGC) symbol 806, which is used by the sidelink device for automatic gain control operations. In an aspect, the AGC symbol 806 may be a duplicate of the second symbol carried by each PRB of the sub-channel in 802. The last symbol carried by each PRB of the SL resource 800 is a guard symbol 808, which does not carry any sidelink data. The SL resource 800 includes a configurable number of contiguous PRBs and symbols for carrying the PSSCH 810. In this example, the PSSCH 810 is carried in the second, third, and fourth symbols of a plurality of contiguous PRBs 812.

With reference again to FIG. 7, the SL resource pool 700 can be shared by several UEs for their SL transmissions. The SL resources of the SL resource pool 700 can be used for all transmission types (i.e., unicast, groupcast, and broadcast). A UE can be (pre-) configured with multiple resource pools for transmission (e.g., transmit resource pools (RPs)) and with multiple resource pools for reception (e.g., receive resource RPs). A UE can receive data on resource pools used for SL transmissions by other UEs and transmit on the SL using its transmit RPs. In certain aspects, exceptional transmit RPs are configured for the UEs for situations that include when a UE is in a transition from idle to connected mode, when a UE experiences a link failure or a handover, or when a UE is changing between different configured transmit RPs. The use of exceptional transmit RPs in such situations aids in improving service continuity.

NR defines at least two resource allocation modes for sidelink communications, one centralized (Mode 1) and one distributed (Mode 2). In Mode 1, the base station (e.g., gNB) schedules sidelink resources to be used by the UE for sidelink transmissions. However, in Mode 2, the UE autonomously determines which sidelink resources of a resource pool the UE will use for transmissions. In Mode 2, the UEs autonomously select their SL resources from a resource pool and can operate without network coverage, such as shown in the example scenario 610 of FIG. 6. The resource pool used by the UEs can be (pre-) configured by a gNB or cNB when the UE is in network coverage or pre-configured as part of the UE design.

Mode 2 uses sensing-based semi-persistent scheduling SPS for periodic traffic. The sensing procedure takes advantage of the periodic and predictable nature of basic sidelink service messages. In sensing-based SPS, the UEs reserve sub-channels in the frequency domain for a random number of consecutive periodic transmissions in the time domain. The number of slots for transmission and retransmissions within each periodic resource reservation period depends on the resource selection procedure. The number of reserved sub-channels per slot depends on the size of data to be transmitted.

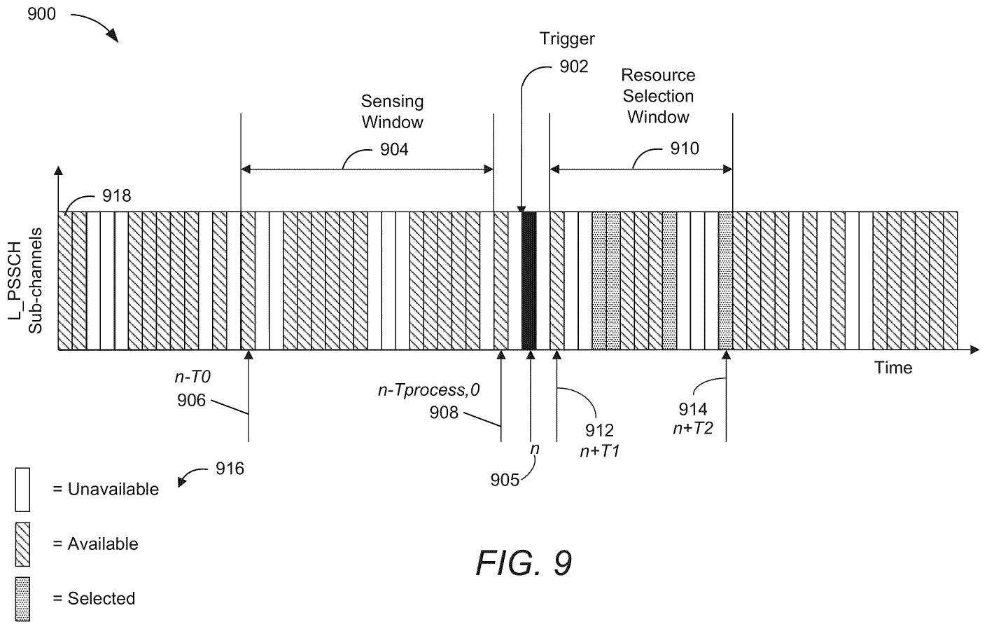

The sensing-based resource selection procedure is composed of two stages: 1) a sensing procedure and 2) a resource selection procedure. In the example shown in FIG. 9, the procedures are executed in response to a trigger event 902. The trigger event 902 may coincide with a number of different event types. In certain aspects, the trigger event 902 may occur on a configurable periodic basis. In certain aspects, the trigger event 902 occurs when a particular task is executed by the UE, such as a positioning operation executed by the UE. A UE can also select new SL resources in response to a re-evaluation or pre-emption condition. For purposes of the following discussion, the resource allocation process originates at slot n 905, shown here as the first slot after the trigger event 902.

The sensing procedure is in charge of identifying the resources which are candidates for resource selection and is based on the decoding of the 1st-stage-SCI received from the surrounding UEs and on sidelink power measurements in terms of RSRP. The sensing procedure is performed during a sensing window 904, which is defined by a pre-configured parameter TO and a specific parameter Tproc,0. The specific parameter Tproc,0 accounts for the time required by the UE to complete decoding the SCIs from other UEs and perform measurements on DMRS of signals transmitted on resources of the other UEs. As shown in FIG. 9, with respect to slot n 905, the UE will consider the sidelink RSRP measurements performed during the interval n−T0 906 to n−Tproc,0 908. Sidelink RSRP measurements can be computed using the power spectral density of the signal received in the PSCCH or in the PSSCH, for which the UE has successfully decoded the 1st-stage-SCI. PSCCH RSRP and PSSCH RSRP are determined as the linear average over the power contributions (in Watts) of the resource elements that carry the DMRS associated with PSCCH and PSSCH, respectively.

Based on the information extracted from the sensing operations, the resource selection procedure determines the resource(s) that the UE may use sidelink transmissions. For that purpose, another interval known as the resource selection window 910 is defined. The resource selection window 910 is defined by the interval n+T1 912 and n+T2 914, where T1 and T2 are two parameters that are determined by the UE implementation. In certain aspects, the value of 72 depends on a packet delay budget (PDB) and on an RRC pre-configured parameter called T2,min. In the case that PDB>T2,min. T2 is determined by the UE implementation and must meet the following condition: T2,min≤T2≤PDB. In the case that PDB≤T2,min, then T2=PDB. T1 is selected so that Tproc,1≤T1, where Tproc,1 is the time required to identify the candidate resources and reserve a subset of resources for sidelink transmission.

The resource selection procedure is composed of two steps. First, the candidate resources within the resource selection window 910 are identified. A resource is indicated as a non-candidate if an SCI is received on that slot or the corresponding slot is reserved by a previous SCI, and the associated sidelink RSRP measurement is above a sidelink RSRP threshold. The resulting set of candidate resources within the resource selection window 910 should be at least X % of the total resources within the resource selection window 910 to proceed with the second step of the resource selection process. The value of X is configured by RRC and, in certain aspects, can be 20%, 35% or 50%. If this condition is not met, the RSRP threshold may be increased by a predetermined amount, such as 3 dB, and the procedure is repeated. Second, the transmitting UE performs the resource selection from the identified candidate resources by reserving the selected resources in its SCI transmission. To exclude resources from the candidate pool based on sidelink measurements in previous slots, the resource reservation period (which is transmitted by the UEs in the 1st-stage-SCI) is introduced. As only the periodicity of transmissions can be extracted from the SCI, the UE that performs the resource selection uses this periodicity (if included in the decoded SCI) and assumes that the UE(s) that transmitted the SCI will do periodic transmissions with such a periodicity, during Q periods. This allows to identify and exclude the non-candidate resources of the resource selection window 910. In accordance with certain aspects of the disclosure.

$$Q = [ \frac{Tscal}{Prsvp} ] ,$$

where Prsvp refers to the resource reservation period decoded from the SCI, and Tscal corresponds to T2 converted to units of ms.

A sidelink resource, such as sidelink resource 918, is defined by one slot in time and L_{PSSCH} contiguous sub-channels in frequency. L_{PSSCH} is an integer in the range 1≤L_{PSSCH}≤max(L_{PSSCH}), where max(L_{PSSCH}) is the total number of sub-channels per slot in the resource selection window 910. However, in certain aspects, the value of max (L_{PSSCH}) can be modified by a congestion control process.

In the example resource allocation process of FIG. 9. T0=20 slots, Tproc,0=2 slots, T1=2 slots, and T2=16 slots. Once the resource selection is triggered at slot n, based on the measurements in the sensing window 904, the UE reserves sidelink resources within the resource selection window 910 for its own transmissions. Visual indicia corresponding to whether a sidelink resource is available, unavailable, or selected (e.g., reserved) in the example are shown in legend 916.

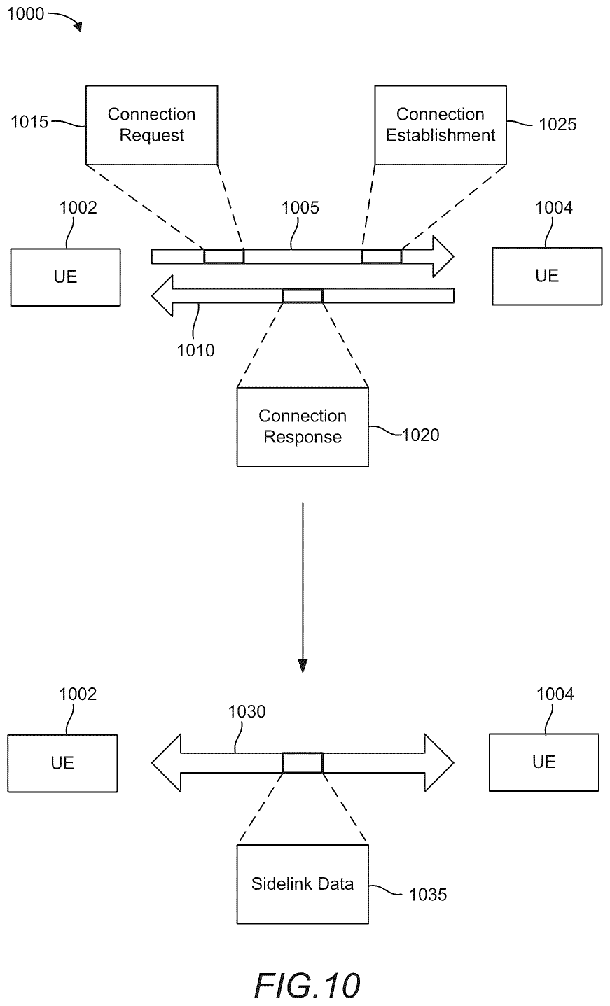

FIG. 10 illustrates an example of a wireless communications system 1000 that supports wireless unicast sidelink establishment, according to aspects of the disclosure. In some examples, wireless communications system 1000 may implement aspects of wireless communications systems 100, 200, and 250. Wireless communications system 1000 may include a first UE 1002 and a second UE 1004, which may be examples of any of the UEs described herein. As specific examples, UEs 1002 and 1004 may correspond to V-UEs 160 in FIG. 1.

In the example of FIG. 10, the UE 1002 may attempt to establish a unicast connection over a sidelink with the UE 1004, which may be a V2X sidelink between the UE 1002 and UE 1004. As specific examples, the established sidelink connection may correspond to sidelinks 162 and/or 168 in FIG. 1. The sidelink connection may be established in an omni-directional frequency range (e.g., FR1) and/or a mmW frequency range (e.g., FR2). In some cases, the UE 1002 may be referred to as an initiating UE that initiates the sidelink connection procedure, and the UE 1004 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 1002 and UE 1004. For example, a transmission and reception capability matching may be negotiated between the UE 1002 and UE 1004. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 1002 and UE 1004. Additionally, a security association may be established between UE 1002 and UE 1004 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally. IP configurations (e.g., IP versions, addresses, etc.) may be negotiated for the unicast connection between UE 1002 and UE 1004.

In some cases, UE 1004 may create a service announcement (e.g., a service capability message) to transmit over a cellular network (e.g., cV2X) to assist the sidelink connection establishment. Conventionally, UE 1002 may identify and locate candidates for sidelink communications based on a basic service message (BSM) broadcasted unencrypted by nearby UEs (e.g., UE 1004). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 1002 is able to detect the BSM(s). Accordingly, the service announcement transmitted by UE 1004 and other nearby UEs (e.g., a discovery signal) may be an upper layer signal and broadcasted (e.g., in an NR sidelink broadcast). In some cases, the UE 1004 may include one or more parameters for itself in the service announcement, including connection parameters and/or capabilities it possesses. The UE 1002 may then monitor for and receive the broadcasted service announcement to identify potential UEs for corresponding sidelink connections. In some cases, the UE 1002 may identify the potential UEs based on the capabilities each UE indicates in their respective service announcements.

The service announcement may include information to assist the UE 1002 (e.g., or any initiating UE) to identify the UE transmitting the service announcement (UE 1004 in the example of FIG. 10). For example, the service announcement may include channel information where direct communication requests may be sent. In some cases, the channel information may be RAT-specific (e.g., specific to LTE or NR) and may include a resource pool within which UE 1002 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 1002 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential sidelink connection target (UE 1004 in the example of FIG. 10), the initiating UE (UE 1002 in the example of FIG. 10) may transmit a connection request 1015 to the identified target UE 1004. In some cases, the connection request 1015 may be a first RRC message transmitted by the UE 1002 to request a unicast connection with the UE 1004 (e.g., an “RRCSetupRequest” message). For example, the unicast connection may utilize the PC5 interface for the sidelink, and the connection request 1015 may be an RRC connection setup request message. Additionally, the UE 1002 may use a sidelink signaling radio bearer 1005 to transport the connection request 1015.

After receiving the connection request 1015, the UE 1004 may determine whether to accept or reject the connection request 1015. The UE 1004 may base this determination on a transmission/reception capability, an ability to accommodate the unicast connection over the sidelink, a particular service indicated for the unicast connection, the contents to be transmitted over the unicast connection, or a combination thereof. For example, if the UE 1002 wants to use a first RAT to transmit or receive data, but the UE 1004 does not support the first RAT, then the UE 1004 may reject the connection request 1015. Additionally or alternatively, the UE 1004 may reject the connection request 1015 based on being unable to accommodate the unicast connection over the sidelink due to limited radio resources, a scheduling issue, etc. Accordingly, the UE 1004 may transmit an indication of whether the request is accepted or rejected in a connection response 1020. Similar to the UE 1002 and the connection request 1015, the UE 1004 may use a sidelink signaling radio bearer 1010 to transport the connection response 1020. Additionally, the connection response 1020 may be a second RRC message transmitted by the UE 1004 in response to the connection request 1015 (e.g., an “RRCResponse” message).

In some cases, sidelink signaling radio bearers 1005 and 1010 may be the same sidelink signaling radio bearer or may be separate sidelink signaling radio bearers. Accordingly, a radio link control (RLC) layer acknowledged mode (AM) may be used for sidelink signaling radio bearers 1005 and 1010. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 1020 indicates that the UE 1004 accepted the connection request 1015, the UE 1002 may then transmit a connection establishment 1025 message on the sidelink signaling radio bearer 1005 to indicate that the unicast connection setup is complete. In some cases, the connection establishment 1025 may be a third RRC message (e.g., an “RRCSetupComplete” message). Each of the connection request 1015, the connection response 1020, and the connection establishment 1025 may use a basic capability when being transported from one UE to the other UE to enable each UE to be able to receive and decode the corresponding transmission (e.g., the RRC messages).

Additionally, identifiers may be used for each of the connection request 1015, the connection response 1020, and the connection establishment 1025. For example, the identifiers may indicate which UE 1002/1004 is transmitting which message and/or for which UE 1002/1004 the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 1015 and/or the connection response 1020 for UE 1002 and/or UE 1004, respectively, to enable negotiation of corresponding AS layer parameters for the unicast connection. For example, the UE 1002 and/or UE 1004 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 1002 and/or UE 1004 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 1002 and/or UE 1004 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 1002 and/or UE 1004 may include PHY layer parameters when establishing the unicast connection to set a PHY layer context for the unicast connection. For example, the PHY layer context may indicate a transmission format (unless transmission profiles are included for each UE 1002/1004) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 1025 message is transmitted). Before a security association (e.g., security context) is established between the UE 1002 and UE 1004, the sidelink signaling radio bearers 1005 and 1010 may not be protected. After a security association is established, the sidelink signaling radio bearers 1005 and 1010 may be protected. Accordingly, the security context may enable secure data transmissions over the unicast connection and the sidelink signaling radio bearers 1005 and 1010. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 1004 may base its decision on whether to accept or reject the connection request 1015 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 1002 and UE 1004 may communicate using the unicast connection over a sidelink 1030, where sidelink data 1035 is transmitted between the two UEs 1002 and 1004. The sidelink 1030 may correspond to sidelinks 162 and/or 168 in FIG. 1. In some cases, the sidelink data 1035 may include RRC messages transmitted between the two UEs 1002 and 1004. To maintain this unicast connection on sidelink 1030. UE 1002 and/or UE 1004 may transmit a keep alive message (e.g., “RRCLinkAlive” message, a fourth RRC message, etc.). In some cases, the keep alive message may be triggered periodically or on-demand (e.g., event-triggered). Accordingly, the triggering and transmission of the keep alive message may be invoked by UE 1002 or by both UE 1002 and UE 1004. Additionally or alternatively, a MAC control element (CE) (e.g., defined over sidelink 1030) may be used to monitor the status of the unicast connection on sidelink 1030 and maintain the connection. When the unicast connection is no longer needed (e.g., UE 1002 travels far enough away from UE 1004), either UE 1002 and/or UE 1004 may start a release procedure to drop the unicast connection over sidelink 1030. Accordingly, subsequent RRC messages may not be transmitted between UE 1002 and UE 1004 on the unicast connection.

NR supports a number of positioning technologies, including downlink-based, uplink-based, and downlink-and-uplink-based positioning methods. Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

In addition to the downlink-based, uplink-based, and downlink-and-uplink-based positioning methods. NR supports various sidelink positioning techniques. For example, link-level ranging signals can be used to estimate the distance between pairs of V-UEs or between a V-UE and a roadside unit (RSU), similar to a round-trip-time (RTT) positioning procedure. Sidelink-based ranging enables the determination of the relative distance(s) between UEs and optionally their absolute position(s), where the absolute position of at least one involved UE is known. This technique is valuable in situations where global navigation satellite system (GNSS) positioning is degraded or unavailable (e.g., tunnels, urban canyons, etc.) and can also enhance range and positioning accuracy when GNSS is available. Sidelink-based ranging can be accomplished using a three-way handshake for session establishment, followed by the exchange of positioning reference signals (PRS), and concluded by messaging to exchange measurements based on PRS transmission and receipt from peer UEs.

Sidelink ranging is based on calculating an inter-UE round-trip-time (RTT) measurement, as determined from the transmit and receive times of PRS (a wideband positioning signal defined in LTE and NR). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute position. UE participation, PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

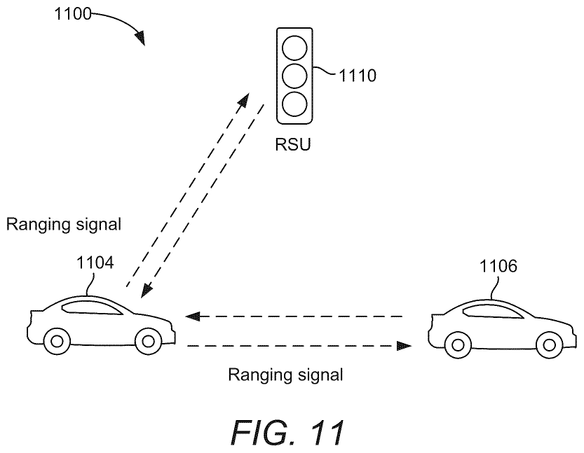

FIG. 11 illustrates an example wireless communication system 1100 in which a V-UE 1104 is exchanging ranging signals with an RSU 1110 and another V-UE 1106, according to aspects of the disclosure. As illustrated in FIG. 11, a wideband (e.g., FR1) ranging signal (e.g., a Zadoff Chu sequence) is transmitted by both end points (e.g., V-UE 1104 and RSU 1110 and V-UE 1104 and V-UE 1106). In an aspect, the ranging signals may be sidelink positioning reference signals (SL-PRS) transmitted by the involved V-UEs 1104 and 1106 on uplink resources. On receiving a ranging signal from a transmitter (e.g., V-UE 1104), the receiver (e.g., RSU 1110 and/or V-UE 1106) responds by sending a ranging signal that includes a measurement of the difference between the reception time of the ranging signal and the transmission time of the response ranging signal, referred to as the reception-to-transmission (Rx-Tx) time difference measurement of the receiver.

Upon receiving the response ranging signal, the transmitter (or other positioning entity) can calculate the RTT between the transmitter and the receiver based on the receiver's Rx-Tx time difference measurement and a measurement of the difference between the transmission time of the first ranging signal and the reception time of the response ranging signal (referred to as the transmission-to-reception (Tx-Rx) time difference measurement of the transmitter). The transmitter (or other positioning entity) uses the RTT and the speed of light to estimate the distance between the transmitter and the receiver. If one or both of the transmitter and receiver are capable of beamforming, the angle between the V-UEs 1104 and 1106 may also be able to be determined. In addition, if the receiver provides its global positioning system (GPS) location in the response ranging signal, the transmitter (or other positioning entity) may be able to determine an absolute location of the transmitter, as opposed to a relative location of the transmitter with respect to the receiver.

As will be appreciated, ranging accuracy improves with the bandwidth of the ranging signals. Specifically, a higher bandwidth can better separate the different multipaths of the ranging signals.

Note that this positioning procedure assumes that the involved V-UEs are time-synchronized (i.e., their system frame time is the same as, or has a known offset relative to, the other V-UE(s)). In addition, although FIG. 11 illustrates two V-UEs, as will be appreciated, they need not be V-UEs, and may instead be any other type of UE capable of sidelink communication.

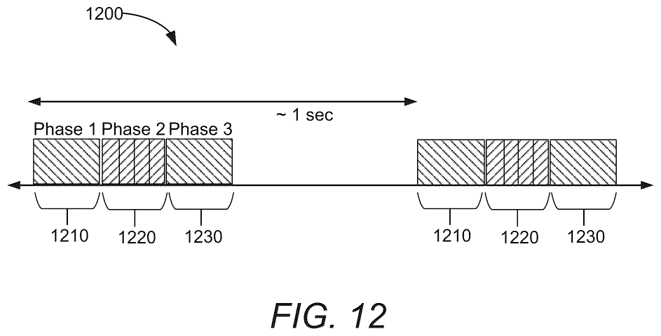

A three-phase protocol can be used for the transmission of ranging signals (e.g., SL-PRS) used for positioning. FIG. 12 is a timeline 1200 illustrating the three-phase communication protocol, according to aspects of the disclosure. As shown in FIG. 12, the three-phase communication protocol occurs periodically, such as every one second. In the first phase 1210, a transmitter (e.g., an RSU, a V-UE, or other sidelink-capable UE) broadcasts the relative location of its antenna(s) (compared to the center location of the transmitter), identifiers (IDs) of the sequences to be transmitted by the antenna(s) in the second phase 1220, and the time/frequency resources on which the sequences will be transmitted in the second phase 1220.

In the second phase 1220, the transmitter transmits wideband sequences (e.g., SL-PRS) having the determined sequence IDs and on the determined time/frequency resources. In the third phase 1230, the transmitter broadcasts its own global positioning system (GPS) location, pseudoranges to one or more satellites, and/or orientation that it had during the second phase. It also broadcasts the times of arrival (ToAs) from the second phase 1220. That is, it broadcasts the ToAs of any SL-PRS received during the second phase 1220 from other transmitters. Note that for V2I positioning, only RSUs need to perform the third phase 1230.

In an aspect, all V-UEs and RSUs may be configured (e.g., by the applicable standard) to follow this three-phase protocol. Thus, during each phase, the transmitter may also receive signals from other V-UEs/RSUs that contain the same type of information as the transmitter transmitted. In that way, both transmitters and receivers can estimate the distances between itself and other V-UEs/RSUs.

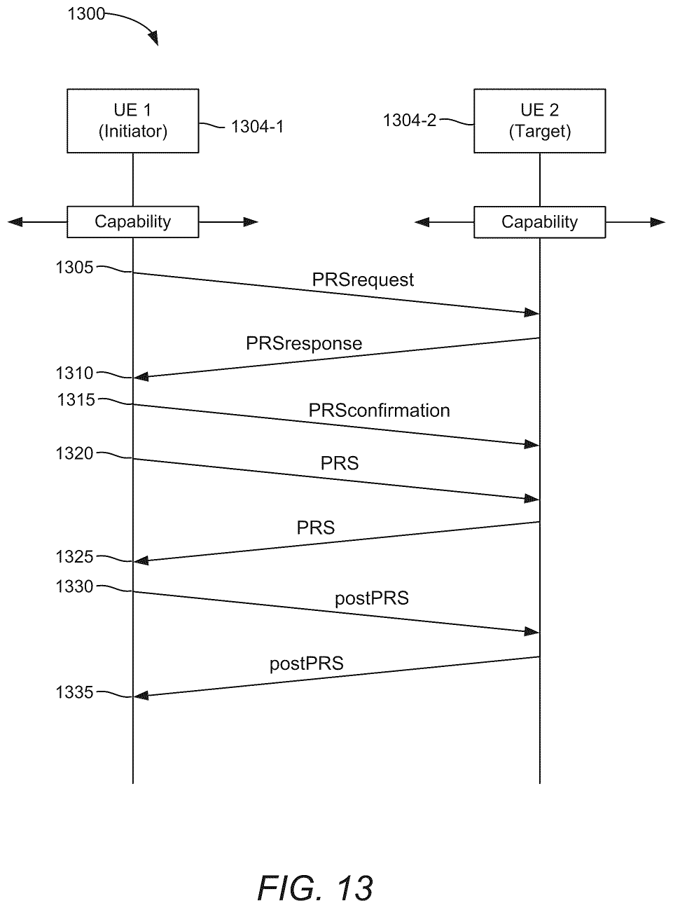

FIG. 13 is a diagram 1300 illustrating an example sidelink ranging and positioning procedure, according to aspects of the disclosure. The procedure (or session) begins with the initial three-way messaging handshake after the broadcast of capability information by the involved peer UEs. At stage 1305, the initiator UE 1304-1 (e.g., any of the UEs described herein) transmits a PRS request (“PRSrequest”) to a target UE 1304-2 (e.g., any other of the UEs described herein). At stage 1310, the target UE 1304-2 transmits a PRS response (“PRSresponse”) to the initiator UE 1304-1. At stage 1315, the initiator UE 1304-1 transmits a PRS confirmation to the target UE 1304-2. At this point, the initial three-way messaging handshake is complete.

At stages 1320 and 1325, the involved peer UEs 1304 transmit PRS to each other. The resources on which the PRS are transmitted may be configured/allocated by the network (e.g., one of the UE's 1304 serving base stations) or negotiated by the UEs 1304 during the initial three-way messaging handshake. The initiator UE 1304-1 measures the reception-to-transmission (Rx-Tx) time difference between the reception time of PRS at stage 1325 and the transmission time of PRS at stage 1320. Similarly, the target UE 1304-2 measures the Rx-Tx time difference between the reception time of PRS at stage 1320 and the transmission time of PRS at stage 1325.

At stages 1330 and 1335, the UE 1304 exchange their respective time difference measurements. Each UE 1304 is then able to determine the RTT between each UE 1304 based on the Rx-Tx time difference measurements (specifically, the difference between the initiator UE's 1304-1 Rx-Tx time difference measurement and the target UE's 1304-2 Rx-Tx time difference measurements). Based on the RTT measurement and the speed of light, each UE 1304 can then estimate the distance between the two UEs 1304 (specifically, half the RTT measurement multiplied by the speed of light).

Note that while FIG. 13 illustrates two UEs 1304, a UE may perform, or attempt to perform, the sidelink ranging and positioning procedure illustrated in FIG. 13 with multiple UEs.

Certain aspects of the disclosure are implemented with a recognition that positioning synchronization sources for positioning of a mobile UE (e.g., a UE used in a vehicle) may change as the UE moves through different positioning environments. Consider a case of an NR positioning session conducted by a UE in a vehicle to support high precision and hybrid positioning. In a first positioning environment, positioning operations are conducted by the UE using a base station (or other TRP), a GNSS, or a UE of a sidelink coordination group as its positioning synchronization source. In an example in which UE positioning uses the base station as the positioning synchronization source, the UE measures positioning signals of positioning resources (e.g., positioning resources configured by the base station or a location server for measurement by the UE during a positioning session) and reports such measurements to the base station or to the location server (e.g., an LMF) via the base station. So long as the UE is in communication with the base station, positioning operations may be maintained using the resources allocated by the base station. At some point, however, the UE may enter a second environment (e.g., a tunnel or other enclosure, a region not serviced by a base station, etc.) in which the UE loses communication with the base and is unable to use the currently configured positioning resources for further positioning operations. When this occurs, the Uu signal or the connection with the base station is lost, and the UE will be dropped from the serving cell. Further, any ongoing positioning sessions will be stopped or otherwise aborted. A similar situation exists when the UE uses a GNSS as the positioning synchronization source and loses the GNSS signal (e.g., due to RF obstructions) as the UE moves through various positioning environments. However, setting up and conducting positioning operations using a new positioning synchronization source can be time-consuming. In certain circumstances, the time that it takes the UE to restart such positioning operations with the new positioning synchronization source may exceed the amount of time required to meet the positioning needs of the UE.

As noted herein, NR supports sidelink positioning between multiple UEs when the UE is not in communication with a base station or GNSS but can nevertheless establish sidelink communications with other UEs (a.k.a., “sidelink UEs” or “sidelink devices”) in the environment. As such, the UE may restart its positioning operations using sidelink positioning once it loses access to its current positioning synchronization source (e.g., base station and/or GNSS). In this regard, the UE may attempt to establish sidelink channel communications with one or more sidelink UEs of a sidelink coordination pool. Once such sidelink channels are established, the UE will try to set the positioning resources and start new positioning sessions using the one or more sidelink UEs. Even then, there may be ambiguities that exist as to which sidelink UE is to be used as the positioning synchronization source of the sidelink coordination pool.

Certain aspects of the disclosure are directed to techniques for reducing the amount of time that it takes a UE to transition between using different positioning resources as the UE gains and loses access to different positioning synchronization sources while moving between different positioning environments. In accordance with certain aspects of the disclosure, the time taken by the UE to transition between using different sets of positioning resources is reduced by pre-configuring the positioning resources associated with a new positioning synchronization source before losing access to positioning resources associated with its current positioning synchronization source. In an aspect, based on prior knowledge of the UE's location, direction, planned roadmap, etc., the UE may schedule in advance or otherwise pre-configure sidelink resources for sidelink positioning sessions that are subsequently activated in response to one or more triggering events. During pre-configuration, the UE takes actions to establish communications with sidelink resources before such resources are needed for positioning operations. Such pre-configuration reduces the amount of time needed by the UE to transition from its use of the current positioning synchronization source to the use of the sidelink resources (e.g., new positioning synchronization source) for positioning. In accordance with certain aspects, the UE pre-configures sidelink resources by exchanging configuration information, capabilities, etc., before the occurrence of the triggering event(s). Such exchanges may take place between the UE and a location server (e.g., an LMF), and/or between the UE and the sidelink devices (e.g., other UEs) that are to be used in the transition. The pre-configured sidelink resources may be the resources used in a sidelink coordination group. In accordance with certain aspects of the disclosure, the UE may pre-configure multiple sets of sidelink resources, where a given set of sidelink resources are to be used in response to one or more specified trigger events.

In an aspect, the current position of the UE is determined based on a first positioning synchronization source (e.g., a base station, a GNSS, or any other positioning synchronization source). While using the first positioning synchronization source for positioning, the UE may be pre-configured with the positioning resources of a sidelink coordination group that will be available if the UE loses the first positioning synchronization source. The sidelink resources that are used for the sidelink coordination group can be determined in a number of different manners. In an aspect, after the UE indicates its positioning capabilities to an LMF, the LMF sends an indication of the sidelink resources that are to be used by the UE for the sidelink coordination group. In an aspect, the UE sends an indication of preferred sidelink devices for use in the sidelink coordination group to the LMF. In an aspect, the UE itself determines the sidelink resources that will be used for the sidelink coordination group and sends an indication of those resources to the LMF.

The UE transitions to using the pre-configured sidelink coordination group for determining the position of the UE in response to one or more triggering events. In accordance with certain aspects of the disclosure, such triggering events indicate that the positioning synchronization source currently used by the UE has become or may become unavailable to the UE. Certain triggering events may be based on signal measurements made by the UE, including, for example, 1) an indication that the UE has lost or is about to lose communication with its serving cell (e.g., an “NR-Uu-positioning-limited” triggering event), 2) an indication that the UE has lost or is about to lose communication with a GNSS (e.g., a “GNSS-coverage-limited” triggering event), 3) an indication that the currently used positioning synchronization source has become or is about to become unavailable to the UE (e.g., “sync-source-change” triggering event), or 4) an indication that one or more signals from the sidelink coordination group are received with a higher signal strength or other signal quality indicator than one or more signals received from the current positioning synchronization source. In an aspect, certain triggering events may be based on the UE's knowledge of its current location with respect to 1) potential obstructions that may interfere with the UE's ability to receive signals from its current positioning synchronization source, or 2) the UE's distance from its current positioning synchronization source. Such triggering events may be map-based where the UEs knows its position with respect to such potential obstructions and/or its distance with respect to certain positioning resources (e.g., distance from a synchronizing base station). Area-based triggering events may include, for example, 1) an indication that the UE has entered or is about to enter a particular geographic area in which the UE is likely to lose communication with a GNSS, or 2) an indication that the UE has entered or is about to enter an area in which the UE is likely to lose communication with the serving cell. In an aspect, the triggering event may include a scheduled transitioning event or an indication received from an LMF that a positioning synchronization source transitioning event has occurred or is about to occur. The UE may respond to one such triggering event or any combination of the foregoing. Based on the teachings of the present disclosure, it will be recognized that other triggering events may be used to transition the UE to use the sidelink coordination group.

Certain aspects of the disclosure may be understood through an example scenario in which a vehicle having a UE enters a tunnel. Prior to entering the tunnel, the UE conducts positioning sessions with an LMF using a first positioning synchronization source (e.g., a base station or GNSS). While outside the tunnel, the UE may report, to an LMF, one or more additional UEs available to the UE for the formation of a sidelink coordination group, where the one or more additional UEs also use the same first positioning synchronization source. The UE may also report its sidelink positioning capabilities to the LMF. Upon receiving the report of the one or more additional UEs available to the UE for the formation of the sidelink coordination group, the LMF defines the positioning resources of the sidelink coordination group that are to be pre-configured by the UE before entering the tunnel, including an indication of which UE of the sidelink coordination group will be used as the new positioning synchronization source.

The UE may pre-configure multiple sidelink coordination groups, each one associated with a different positioning synchronization source. As an example, the UE may pre-configure a first sidelink coordination group using GNSS and a second sidelink coordination group using the serving base station. With respect to the first group, the UE performs sidelink discovery, and executes sidelink coordination group creation and management procedures using GNSS. With respect to the second group, the UE performs sidelink discovery, and executes sidelink coordination group creation and management procedures using the serving base station. The UE can keep track of both groups (e.g., changes, removals and additions of UEs to the group, etc.) while either one or both groups are actively used by the UE for positioning.

In certain aspects, the UE itself determines and pre-configures the sidelink coordination group(s) that it will use. The UE may report the sidelink coordination group(s) it has created, as well as indicate the sync source of each group, to the LMF. In certain aspects, the LMF may request the UE to activate one or more of the groups in association with a Uu-positioning or GNSS-positioning session. In accordance with certain aspects, the LMF may request the UE to activate one or more of the groups when a specific triggering event occurs.

When the UE enters the tunnel, it loses contact with the first positioning synchronization source. This loss acts as a trigger causing the UE to transition to using the pre-configured sidelink resources of the sidelink coordination group for positioning. The UE then uses the pre-configured sidelink resources for positioning as the UE passes through the tunnel. Since the sidelink resources for positioning have been pre-configured, there is little to no delay in starting the positioning session inside the tunnel using the new positioning synchronization source.

In accordance with certain aspects of the disclosure, the transition to using the pre-configured sidelink resources may also include a transition of the positioning mode of the UE from a UE-assisted mode outside the tunnel to a UE-based mode inside the tunnel. In the UE-assisted mode, the UE measures signals of positioning resources indicated by the LMF and reports those measurements to the LMF, which determines the position of the UE using the reported measurements. In the UE-based mode, the UE measures signals of the positioning resources of the sidelink coordination group and uses those measurements to determine its own position. In certain aspects, the LMF indicates the positioning mode that is to be used by the UE as the UE inside passes through the tunnel. As an example, the LMF may indicate that the UE is only to support the UE-assisted mode for positioning while it has a connection to the first positioning synchronization source via the NR Uu link. Further, the LMF may indicate that the UE is to use the UE-based method for positioning when using communicating with resources of the sidelink coordination group via the NR SL link (PC5). The ability to operate in both such modes may be indicated to the LMF when the UE reports its positioning capabilities.

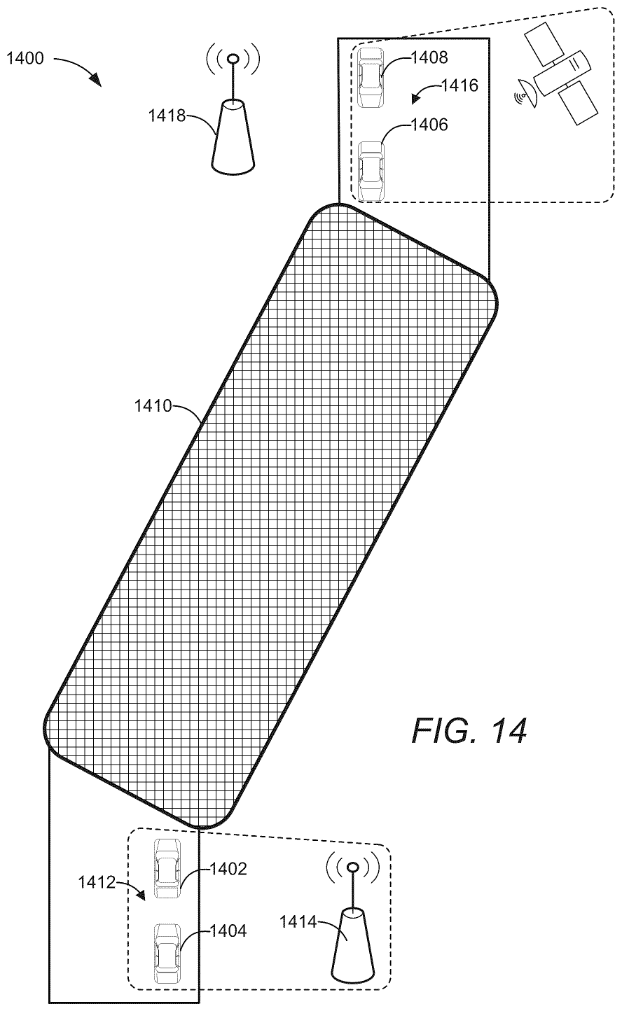

Example scenarios in which multiple vehicles having respective UEs pass through a tunnel is illustrated in FIGS. 14 to 19. For purposes of discussing the scenarios of FIG. 14-19, any reference to “vehicle” is synonymous with the respective UE used by the vehicle.

FIG. 14 shows an example scenario 1400 in which four vehicles 1402, 1404, 1406, and 1408, each having its own UE for positioning, pass through a tunnel 1410. Here, vehicles 1402 and 1404 approach a first end of the tunnel 1410, as vehicles 1408 and 1406 approach a second end of the tunnel 1410. Signals from one or more serving base stations and/or signals from a GNSS are available to the vehicles 1402, 1404, 1406, and 1408 outside the tunnel but are not available inside the tunnel.

As shown in FIG. 14, vehicles 1402 and 1404 pre-configure their sidelink resources and form a sidelink coordination group 1412 with the assistance of serving base station 1414 synchronization. Vehicle 1402 is designated as the positioning synchronization source for the sidelink coordination group 1412. Similarly, vehicles 1406 and 1408 pre-configure their sidelink resources and form a sidelink coordination group 1416 with the assistance of GNSS synchronization. Vehicle 1406 is designated as the positioning synchronization source for the sidelink coordination group 1416. In this example, base station 1418 does not play a role in the formation of the sidelink coordination groups at this point.

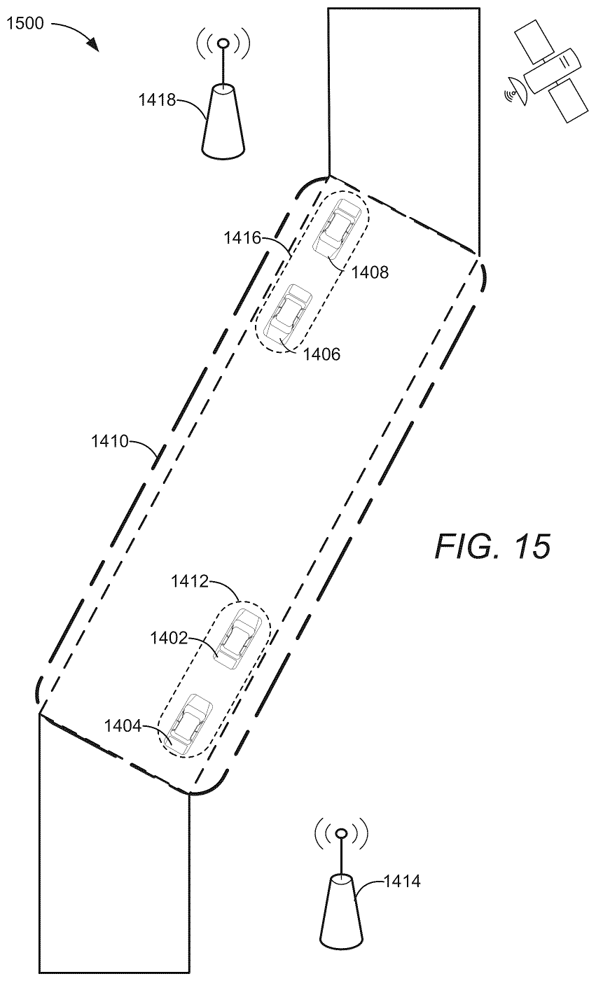

FIG. 15 shows an example scenario 1500 in which the vehicles 1402, 1404, 1406, and 1408 have just entered the tunnel 1410. Upon entering the tunnel 1410, the vehicles of sidelink coordination group 1412 lose connection with base station 1414, triggering the vehicles 1402 and 1404 to transition to using the sidelink resources of the sidelink coordination group 1412 for positioning, with vehicle 1402 operating as the positioning synchronization source. Similarly, upon entering the tunnel 1410, the vehicles of sidelink coordination group 1416 lose connection with the GNSS, triggering the vehicles 1406 and 1408 to transition to using the sidelink resources of the sidelink coordination group 1416 for positioning, with vehicle 1406 operating as the positioning synchronization source.

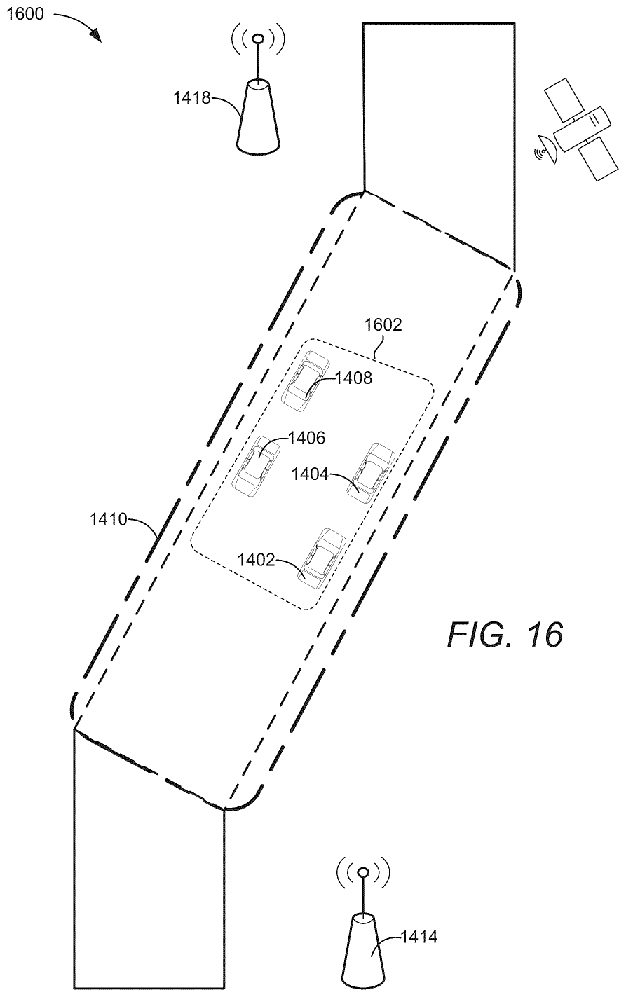

FIG. 16 shows an example scenario in which the vehicles 1402, 1404, 1406, and 1408 approach a mid-portion of the tunnel 1410. In this scenario, the vehicles 1402, 1404, 1406, and 1408 are within the communication range of each other. In certain aspects, each vehicle 1402, 1404, 1406, and 1408 monitors the sidelink resources of every other vehicle 1402, 1404, 1406, and 1408 while conducting positioning sessions within their respective sidelink coordination groups. In this example, the vehicles 1402, 1404, 1406, and 1408 each pre-configure sidelink resources to form a common sidelink coordination group 1602 and designate vehicle 1402 as the positioning synchronization source for the group. In response to another triggering event (e.g., one or more of the triggering events discussed above), the vehicles 1402, 1404, 1406, and 1408 transition to using the common sidelink coordination group 1602 for positioning, with vehicle 1402 as the positioning synchronization source.

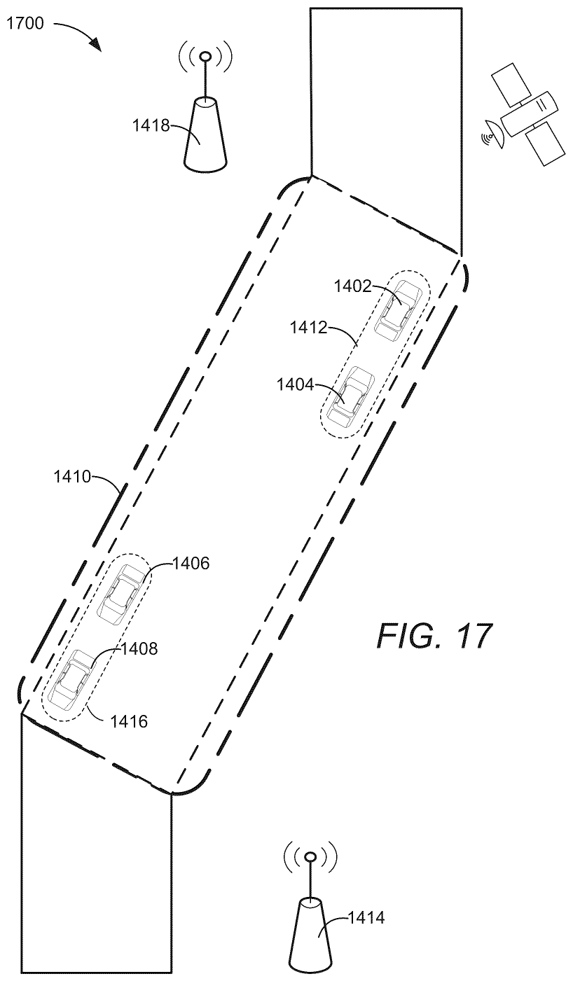

FIG. 17 shows an example scenario 1700 in which the vehicles 1402, 1404, 1406, and 1408 approach opposite ends of the tunnel 1410. In this scenario, the vehicles 1402, 1404, are no longer in communication range of the vehicles 1406 and 1408. However, prior to losing communication, vehicles 1402 and 1404 have pre-configured sidelink resources used in their original sidelink coordination group 1412. Similarly, prior to losing communication, vehicles 1406 and 1408 have pre-configured sidelink resources used in their original sidelink coordination group 1416. In response to yet another triggering event (e.g., one or more of the triggering events discussed above), the vehicles 1402 and 1404 transition to using the sidelink coordination group 1416 for positioning, with vehicle 1402 as the positioning synchronization source. Likewise, in response to the triggering event, the vehicles 1406 and 1408 transition to using the sidelink coordination group 1416 for positioning, with vehicle 1406 as the positioning synchronization source.

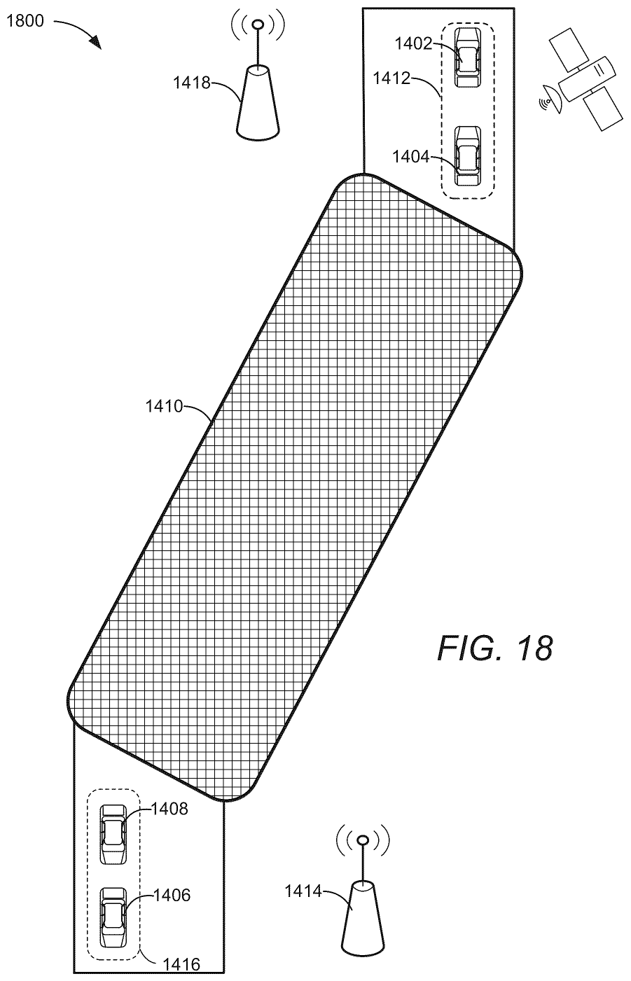

FIG. 18 shows an example scenario 1800 in which the vehicles 1402, 1404, 1406, and 1408 exit opposite sides of the tunnel 1410. In this example, the GNSS and base station 1418 are available as a positioning synchronization source for vehicles 1402 and 1404. However, the vehicles 1402 and 1404 continue to use the sidelink resources of the sidelink coordination group 1412 for positioning while coordinating with base station 1418 to pre-configure positioning resources that will be used by the vehicles 1402 and 1404 outside the tunnel 1410. Similarly, base station 1414 is available as a positioning synchronization source for vehicles 1402 and 1404. However, the vehicles 1406 and 1408 continue to use the sidelink resources of the sidelink coordination group 1416 for positioning while coordinating with base station 1418 to pre-configure positioning resources that will be used by the vehicles 1402 and 1404 outside the tunnel 1410.

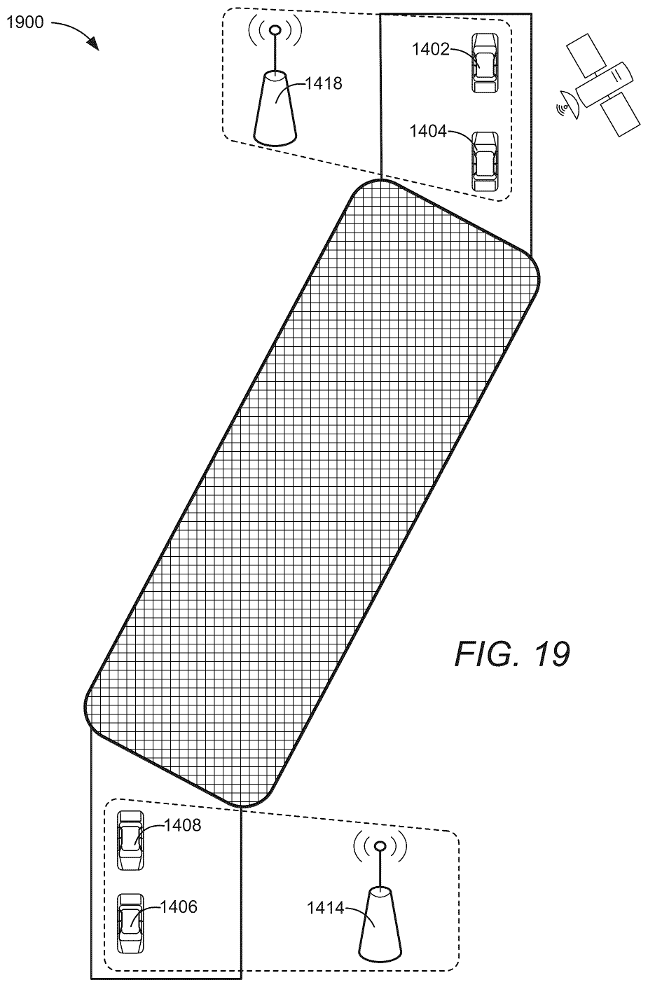

FIG. 19 shows an example scenario 1900 in which the vehicles 1402, 1404, 1406, and 1408 have exited the tunnel 1410. In response to a triggering event, vehicles 1402 and 1404 transition to using the positioning resources that were pre-configured in conjunction with base station 1418. While using the positioning resources that were pre-configured in conjunction with base station 1418, vehicles 1402 and 1404 may continue with pre-configuring sidelink resources that may ultimately be used in response to other transitioning events associated with one or both vehicles 1402 and 1404. Similarly, in response to a triggering event, vehicles 1406 and 1408 transition to using the positioning resources that were pre-configured in conjunction with base station 1414 for positioning. While using the positioning resources that were pre-configured in conjunction with base station 1414, vehicles 1406 and 1408 may continue with pre-configuring sidelink resources that may ultimately be used in response to other transitioning events associated with one or both vehicles 1406 and 1408.

With reference again to FIG. 16, scenario 1600 merely shows one example of a transition that may occur when all of the vehicles 1402, 1404, 1406, and 1408 are mid-tunnel and out of communication with external positioning synchronization sources (e.g., base stations, GNSS, etc.). However, each vehicle 1402, 1404, 1406, and 1408 may pre-configure sidelink resources other than those described with respect to scenario 1600. Additionally, various trigger events may be used by one or more of the vehicles 1402, 1404, 1406, and 1408 to initiate a transition to such pre-configured sidelink resources. Such triggering events may include, for example, 1) an indication that the vehicle has lost or is about to lose communication with a positioning synchronization source of the current sidelink coordination group, 2) an indication that the vehicle has entered or is about to enter an area in which the vehicle is likely to lose communication with one or more sidelink resources of the current sidelink coordination group. 3) an indication that a positioning synchronization source used by the current sidelink coordination group has become or is about to become unavailable to the vehicle, 4) an indication that the vehicle has entered or is about to enter a specified geographical area in the tunnel, 5) an indication that one or more signals from another sidelink coordination group are received with a higher signal strength or other signal quality indicator than one or more signals received from the current sidelink coordination group, 6) an indication that one or more sidelink resources of the current sidelink coordination group have become or are about to become unavailable to the vehicle, 7) a scheduled transitioning event, or 8) any combination of the foregoing.

The vehicles may pre-configure one or more sidelink coordination groups mid-tunnel. For example, a vehicle may configure 1) a further sidelink coordination group that includes at least one vehicle that is not included in the current sidelink coordination group, 2) a further sidelink coordination group that includes fewer vehicles than included in the current sidelink coordination group; 3) a further sidelink coordination group that includes at least one vehicle that is also included in the current sidelink coordination group, 4) a further sidelink coordination group that uses a synchronization vehicle that is different from the synchronization vehicle used in the current sidelink coordination group, or 5) any combination of the foregoing.

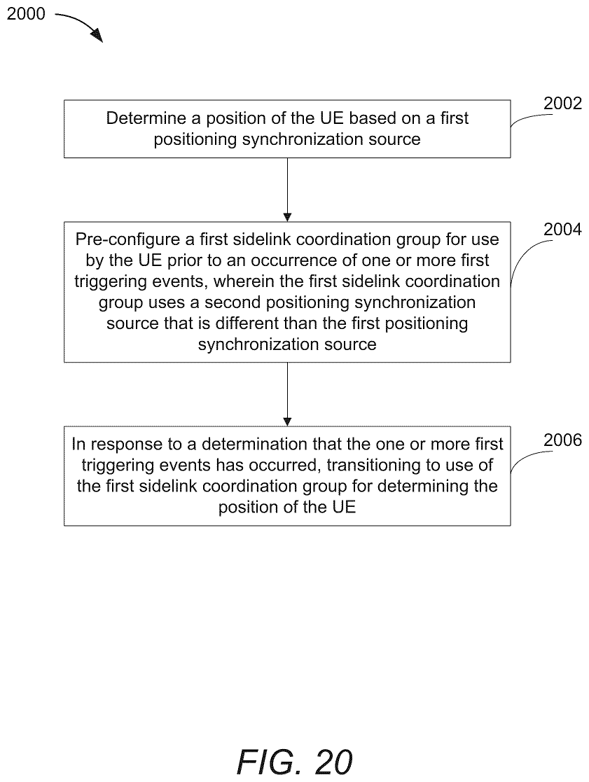

FIG. 20 shows an example method 2000 of wireless communication that may be performed by a user equipment (UE) in accordance with aspects of the disclosure. At operation 2002, the UE determines a position of the UE based on a first positioning synchronization source. In accordance with certain aspects, the first positioning synchronization source may be a base station, GNSS, etc. In an aspect, operation 2002 may be performed by the one or more WWAN transceivers 310, the one or more processors 332, memory 340, satellite signal receiver 330, and/or sidelink component 342, any or all of which may be considered means for performing this operation.

At operation 2004, the UE pre-configures a first sidelink coordination group for use by the UE prior to an occurrence of one or more first triggering events, wherein the first sidelink coordination group uses a second positioning synchronization source that is different than the first positioning synchronization source. In certain aspects, the first sidelink coordination group may include multiple V-UEs, where one of the V-UEs is used as the synchronization source for the first sidelink coordination group. In an aspect, operation 2004 may be performed by the one or more WWAN transceivers 310, the one or more processors 332, memory 340, satellite signal receiver 330, and/or sidelink component 342, any or all of which may be considered means for performing this operation.

At operation 2006, the UE, in response to a determination that the one or more first triggering events has occurred, transitions to use of the first sidelink coordination group for determining the position of the UE. In certain aspects, the one or more first triggering events may correspond to events indicating that the UE has lost or is about to lose communication with the first synchronization source. Additionally, or in the alternative, the one or more first triggering events may correspond to a scheduled switch in synchronization sources. In certain aspects, any of the triggering events discussed above can serve as the one or more first triggering events. In an aspect, operation 2006 may be performed by the one or more WWAN transceivers 310, the one or more processors 332, memory 340, satellite signal receiver 330, and/or sidelink component 342, any or all of which may be considered means for performing this operation.

As will be appreciated, a technical advantage of the method 2000 is that the UE may decrease the time required for the UE to transition from positioning using a current set of positioning resources to positioning using a new set of positioning resources since the new positioning resources have been pre-configured at the UE before the transition is needed.

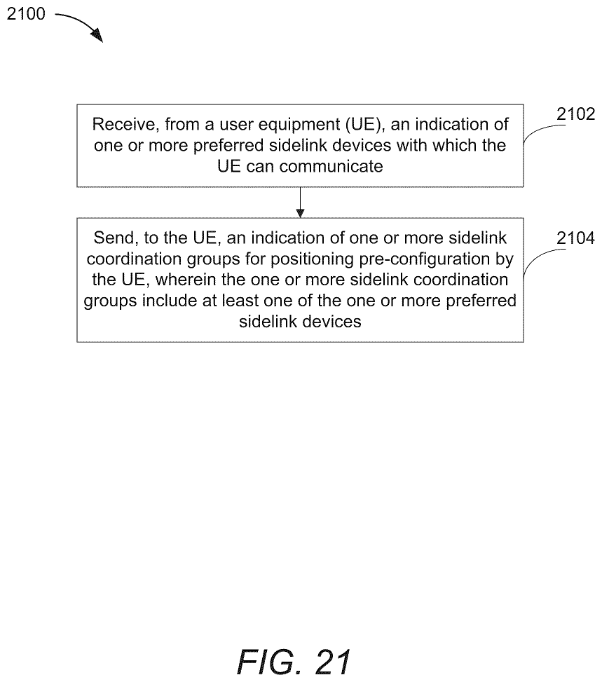

FIG. 21 shows an example method 2100 of wireless communication that may be performed by a location server in accordance with aspects of the disclosure. At operation 2102, the location server receives, from a user equipment (UE), an indication of one or more preferred sidelink devices with which the UE can communicate. In an aspect, operation 2102 may be performed by the one or more network transceivers 390, the one or more processors 394, memory 396, and/or sidelink component 398, any or all of which may be considered means for performing this operation.

At operation 2104, the location server sends, to the UE, an indication of one or more sidelink coordination groups for positioning pre-configuration by the UE, wherein the one or more sidelink coordination groups include at least one of the one or more preferred sidelink devices. In an aspect, operation 2102 may be performed by the one or more network transceivers 390, the one or more processors 394, memory 396, and/or sidelink component 398, any or all of which may be considered means for performing this operation.

As will be appreciated, a technical advantage of the method 2100 is that the LMF indicates one or more sidelink coordination groups to the UE that may be pre-configured before the occurrence of a triggering event that initiates a transition from positioning using a given positioning synchronization source to positioning using the one or more sidelink coordination groups. This assists the UE in decreasing the time required for the UE to transition from positioning using a current set of positioning resources to positioning using a new set of positioning resources since the new positioning resources have been pre-configured at the UE before the transition is needed. Further, the LMF may set the events that are to be used by the UE to initiate the transition.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: determining a position of the UE based on a first positioning synchronization source; pre-configuring a first sidelink coordination group for use by the UE prior to an occurrence of one or more first triggering events, wherein the first sidelink coordination group uses a second positioning synchronization source that is different than the first positioning synchronization source; and in response to a determination that the one or more first triggering events has occurred, transitioning to use of the first sidelink coordination group for determining the position of the UE.

Clause 2. The method of clause 1, wherein: the first positioning synchronization source is at least one of a base station or a Global Navigation Satellite System (GNSS).

Clause 3. The method of any of clauses 1 to 2, wherein: the position of the UE using the first positioning synchronization source is determined in a UE-assisted positioning mode.

Clause 4. The method of clause 3, wherein: the position of the UE using the first sidelink coordination group is determined in a UE-based positioning mode.

Clause 5. The method of any of clauses 1 to 4, wherein: the one or more first triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the first positioning synchronization source has become or is about to become unavailable to the UE, an indication that one or more signals from the first sidelink coordination group are received with a higher signal strength or other signal quality indicator than one or more signals received from the first positioning synchronization source, an indication that the UE has entered or is about to enter an area in which the UE is likely to lose communication with the GNSS, an indication that the UE has entered or is about to enter a specified geographical area, a scheduled transitioning event, an indication received from a location server that a positioning synchronization source transitioning event has occurred or is about to occur, or any combination thereof.

Clause 6. The method of any of clauses 1 to 5, further comprising: sending one or more positioning capabilities of the UE to a location server.

Clause 7. The method of any of clauses 1 to 6, further comprising: determining, by the UE, a recommended triggering event for transitioning to use of the first sidelink coordination group; and sending an indication of the recommended triggering event to a location server.

Clause 8. The method of any of clauses 1 to 7, further comprising: determining the position of the UE based on the first positioning synchronization source while monitoring sidelink resources of the first sidelink coordination group to pre-configure the first sidelink coordination group.

Clause 9. The method of any of clauses 1 to 8, further comprising: sending, to a location server, an indication of one or more preferred sidelink devices for use in the first sidelink coordination group.

Clause 10. The method of any of clauses 1 to 9, further comprising: receiving, from a location server, an indication of sidelink resources for the first sidelink coordination group.

Clause 11. The method of any of clauses 1 to 10, further comprising: determining the first sidelink coordination group at the UE; and sending an indication of the first sidelink coordination group to a location server.

Clause 12. The method of clause 11, further comprising: pre-configuring the first sidelink coordination group based, at least in part, on sidelink discovery operations conducted by the UE.

Clause 13. The method of any of clauses 1 to 12, further comprising: pre-configuring sidelink resources of a second sidelink coordination group.

Clause 14. The method of clause 13, further comprising: using the first sidelink coordination group for positioning while monitoring sidelink resources of the second sidelink coordination group.

Clause 15. The method of any of clauses 1 to 14, further comprising: determining that one or more second triggering events have occurred; and in response to a determination that the one or more second triggering events have occurred, transitioning to use of a second sidelink coordination group for determining the position of the UE, wherein the second sidelink coordination group is pre-configured at the UE prior to the occurrence of the one or more second triggering events.

Clause 16. The method of clause 15, wherein: the one or more second triggering events include an indication that the UE has lost or is about to lose communication with a positioning synchronization source of the first sidelink coordination group, an indication that the UE has entered or is about to enter an area in which the UE is likely to lose communication with one or more sidelink resources of the first sidelink coordination group, an indication that a positioning synchronization source used by the first sidelink coordination group has become or is about to become unavailable to the UE, a scheduled transitioning event, an indication that the UE has entered or is about to enter a specified geographical area, an indication that one or more signals from the second sidelink coordination group are received with a higher signal strength or other signal quality indicator than one or more signals received from the first sidelink coordination group, an indication that one or more sidelink resources of the first sidelink coordination group have become or are about to become unavailable to the UE, or any combination thereof.

Clause 17. The method of clause 16, wherein: the second sidelink coordination group includes at least one sidelink user equipment (UE) that is not included in the first sidelink coordination group; the second sidelink coordination group includes fewer sidelink UEs than included in the first sidelink coordination group; the second sidelink coordination group includes at least one sidelink UE that is included in the first sidelink coordination group; the second sidelink coordination group uses a second synchronization sidelink UE that is different from a first synchronization sidelink UE used in the first sidelink coordination group; or any combination thereof.

Clause 18. The method of any of clauses 1 to 17, further comprising: sending, to a location server, an indication of one or more preferred sidelink devices for use in one or more sidelink coordination groups.

Clause 19. A method of wireless communication performed by a location server, comprising: receiving, from a user equipment (UE), an indication of one or more preferred sidelink devices with which the UE can communicate; and sending, to the UE, an indication of one or more sidelink coordination groups for positioning pre-configuration by the UE, wherein the one or more sidelink coordination groups include at least one of the one or more preferred sidelink devices.

Clause 20. The method of clause 19, further comprising: sending, to the UE, an indication of one or more triggering events to be used by the UE to initiate a transition from positioning based on a first positioning synchronization source to positioning with a first sidelink coordination group of the one or more sidelink coordination groups.

Clause 21. The method of any of clauses 19 to 20, further comprising: receiving, from the UE, an indication of one or more preferred sidelink resources for inclusion in the one or more sidelink coordination groups.

Clause 22. The method of any of clauses 19 to 21, wherein: the one or more triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the UE has entered or is about to enter an area in which the UE is likely to lose communication with the GNSS, an indication that the UE has entered or is about to enter a specified geographical area, an indication that a first positioning synchronization source currently used by the UE for positioning has become or is about to become unavailable to the UE, an indication that one or more signals from a first sidelink coordination group are received with a higher signal strength or other signal quality indicator than one or more signals received from a second sidelink coordination group, a scheduled transitioning event, an indication received from the location server that a positioning synchronization source transitioning event has occurred or is about to occur, or any combination thereof.

Clause 23. A user equipment (UE), comprising: a memory; at least one transceiver; and at least one processor communicatively coupled to the memory and the at least one transceiver, the at least one processor configured to: determine a position of the UE based on a first positioning synchronization source; pre-configure a first sidelink coordination group for use by the UE prior to an occurrence of one or more first triggering events, wherein the first sidelink coordination group uses a second positioning synchronization source that is different than the first positioning synchronization source; and in response to a determination that the one or more first triggering events has occurred, transitioning to use of the first sidelink coordination group for determining the position of the UE.

Clause 24. The UE of clause 23, wherein: the first positioning synchronization source is at least one of a base station or a Global Navigation Satellite System (GNSS).

Clause 25. The UE of any of clauses 23 to 24, wherein: the position of the UE using the first positioning synchronization source is determined in a UE-assisted positioning mode.

Clause 26. The UE of clause 25, wherein: the position of the UE using the first sidelink coordination group is determined in a UE-based positioning mode.

Clause 27. The UE of any of clauses 23 to 26, wherein: the one or more first triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the first positioning synchronization source has become or is about to become unavailable to the UE, an indication that one or more signals from the first sidelink coordination group are received with a higher signal strength or other signal quality indicator than one or more signals received from the first positioning synchronization source, an indication that the UE has entered or is about to enter an area in which the UE is likely to lose communication with the GNSS, an indication that the UE has entered or is about to enter a specified geographical area, a scheduled transitioning event, an indication received from a location server that a positioning synchronization source transitioning event has occurred or is about to occur, or any combination thereof.

Clause 28. The UE of any of clauses 23 to 27, wherein the at least one processor is further configured to: send, via the at least one transceiver, one or more positioning capabilities of the UE to a location server.

Clause 29. The UE of any of clauses 23 to 28, wherein the at least one processor is further configured to: determine a recommended triggering event for transitioning to use of the first sidelink coordination group; and send, via the at least one transceiver, an indication of the recommended triggering event to a location server.

Clause 30. The UE of any of clauses 23 to 29, wherein the at least one processor is further configured to: determine the position of the UE based on the first positioning synchronization source while monitoring sidelink resources of the first sidelink coordination group to pre-configure the first sidelink coordination group.

Clause 31. The UE of any of clauses 23 to 30, wherein the at least one processor is further configured to: send, via the at least one transceiver, to a location server, an indication of one or more preferred sidelink devices for use in the first sidelink coordination group.

Clause 32. The UE of any of clauses 23 to 31, wherein the at least one processor is further configured to: receive, via the at least one transceiver, from a location server, an indication of sidelink resources for the first sidelink coordination group.

Clause 33. The UE of any of clauses 23 to 32, wherein the at least one processor is further configured to: determine the first sidelink coordination group at the UE; and send, via the at least one transceiver, an indication of the first sidelink coordination group to a location server.

Clause 34. The UE of clause 33, wherein the at least one processor is further configured to: pre-configure the first sidelink coordination group based, at least in part, on sidelink discovery operations conducted by the UE.

Clause 35. The UE of any of clauses 23 to 34, wherein the at least one processor is further configured to: pre-configure sidelink resources of a second sidelink coordination group.

Clause 36. The UE of clause 35, wherein the at least one processor is further configured to: use the first sidelink coordination group for positioning while monitoring sidelink resources of the second sidelink coordination group.

Clause 37. The UE of any of clauses 23 to 36, wherein the at least one processor is further configured to: determine that one or more second triggering events have occurred; and in response to a determination that the one or more second triggering events have occurred, transitioning to use of a second sidelink coordination group for determining the position of the UE, wherein the second sidelink coordination group is pre-configured at the UE prior to the occurrence of the one or more second triggering events.

Clause 38. The UE of clause 37, wherein: the one or more second triggering events include an indication that the UE has lost or is about to lose communication with a positioning synchronization source of the first sidelink coordination group, an indication that the UE has entered or is about to enter an area in which the UE is likely to lose communication with one or more sidelink resources of the first sidelink coordination group, an indication that a positioning synchronization source used by the first sidelink coordination group has become or is about to become unavailable to the UE, a scheduled transitioning event, an indication that the UE has entered or is about to enter a specified geographical area, an indication that one or more signals from the second sidelink coordination group are received with a higher signal strength or other signal quality indicator than one or more signals received from the first sidelink coordination group, an indication that one or more sidelink resources of the first sidelink coordination group have become or are about to become unavailable to the UE, or any combination thereof.

Clause 39. The UE of clause 38, wherein: the second sidelink coordination group includes at least one sidelink user equipment (UE) that is not included in the first sidelink coordination group; the second sidelink coordination group includes fewer sidelink UEs than included in the first sidelink coordination group; the second sidelink coordination group includes at least one sidelink UE that is included in the first sidelink coordination group; the second sidelink coordination group uses a second synchronization sidelink UE that is different from a first synchronization sidelink UE used in the first sidelink coordination group; or any combination thereof.

Clause 40. The UE of any of clauses 23 to 39, wherein the at least one processor is further configured to: send, via the at least one transceiver, to a location server, an indication of one or more preferred sidelink devices for use in one or more sidelink coordination groups.

Clause 41. A location server, comprising: a memory; at least one transceiver; and at least one processor communicatively coupled to the memory and the at least one transceiver, the at least one processor configured to: receive, via the at least one transceiver, from a user equipment (UE), an indication of one or more preferred sidelink devices with which the UE can communicate; and send, via the at least one transceiver, to the UE, an indication of one or more sidelink coordination groups for positioning pre-configuration by the UE, wherein the one or more sidelink coordination groups include at least one of the one or more preferred sidelink devices.

Clause 42. The location server of clause 41, wherein the at least one processor is further configured to: send, via the at least one transceiver, to the UE, an indication of one or more triggering events to be used by the UE to initiate a transition from positioning based on a first positioning synchronization source to positioning with a first sidelink coordination group of the one or more sidelink coordination groups.

Clause 43. The location server of any of clauses 41 to 42, wherein: receive, via the at least one transceiver, from the UE, an indication of one or more preferred sidelink resources for inclusion in the one or more sidelink coordination groups.

Clause 44. The location server of any of clauses 42 to 43, wherein: the one or more triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the UE has entered or is about to enter an area in which the UE is likely to lose communication with the GNSS, an indication that the UE has entered or is about to enter a specified geographical area, an indication that a first positioning synchronization source currently used by the UE for positioning has become or is about to become unavailable to the UE, an indication that one or more signals from a first sidelink coordination group are received with a higher signal strength or other signal quality indicator than one or more signals received from a second sidelink coordination group, a scheduled transitioning event, an indication received from the location server that a positioning synchronization source transitioning event has occurred or is about to occur, or any combination thereof.

Clause 45. A user equipment (UE), comprising: means for determining a position of the UE based on a first positioning synchronization source; means for pre-configuring a first sidelink coordination group for use by the UE prior to an occurrence of one or more first triggering events, wherein the first sidelink coordination group uses a second positioning synchronization source that is different than the first positioning synchronization source; and means for transitioning to use of the first sidelink coordination group for determining the position of the UE in response to the occurrence of the one or more first triggering events.

Clause 46. The UE of clause 45, wherein: the first positioning synchronization source is at least one of a base station or a Global Navigation Satellite System (GNSS).

Clause 47. The UE of any of clauses 45 to 46, wherein: the position of the UE using the first positioning synchronization source is determined in a UE-assisted positioning mode.

Clause 48. The UE of clause 47, wherein: the position of the UE using the first sidelink coordination group is determined in a UE-based positioning mode.

Clause 49. The UE of any of clauses 45 to 48, wherein: the one or more first triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the first positioning synchronization source has become or is about to become unavailable to the UE, an indication that one or more signals from the first sidelink coordination group are received with a higher signal strength or other signal quality indicator than one or more signals received from the first positioning synchronization source, an indication that the UE has entered or is about to enter an area in which the UE is likely to lose communication with the GNSS, an indication that the UE has entered or is about to enter a specified geographical area, a scheduled transitioning event, an indication received from a location server that a positioning synchronization source transitioning event has occurred or is about to occur, or any combination thereof.

Clause 50. The UE of any of clauses 45 to 49, further comprising: means for sending one or more positioning capabilities of the UE to a location server.

Clause 51. The UE of any of clauses 45 to 50, further comprising: means for determining a recommended triggering event for transitioning to use of the first sidelink coordination group; and means for sending an indication of the recommended triggering event to a location server.

Clause 52. The UE of any of clauses 45 to 51, further comprising: means for determining the position of the UE based on the first positioning synchronization source while monitoring sidelink resources of the first sidelink coordination group to pre-configure the first sidelink coordination group.

Clause 53. The UE of any of clauses 45 to 52, further comprising: means for sending, to a location server, an indication of one or more preferred sidelink devices for use in the first sidelink coordination group.

Clause 54. The UE of any of clauses 45 to 53, further comprising: means for receiving, from a location server, an indication of sidelink resources for the first sidelink coordination group.

Clause 55. The UE of any of clauses 45 to 54, further comprising: means for determining the first sidelink coordination group at the UE; and means for sending an indication of the first sidelink coordination group to a location server.

Clause 56. The UE of clause 55, further comprising: means for pre-configuring the first sidelink coordination group based, at least in part, on sidelink discovery operations conducted by the UE.

Clause 57. The UE of any of clauses 45 to 56, further comprising: means for pre-configuring sidelink resources of a second sidelink coordination group.

Clause 58. The UE of clause 57, further comprising: means for using the first sidelink coordination group for positioning while monitoring sidelink resources of the second sidelink coordination group.

Clause 59. The UE of any of clauses 45 to 58, further comprising: means for determining that one or more second triggering events have occurred; and means for transitioning to use of a second sidelink coordination group for determining the position of the UE in response to a determination that the one or more second triggering events have occurred, wherein the second sidelink coordination group is pre-configured at the UE prior to the occurrence of the one or more second triggering events.

Clause 60. The UE of clause 59, wherein: the one or more second triggering events include an indication that the UE has lost or is about to lose communication with a positioning synchronization source of the first sidelink coordination group, an indication that the UE has entered or is about to enter an area in which the UE is likely to lose communication with one or more sidelink resources of the first sidelink coordination group, an indication that a positioning synchronization source used by the first sidelink coordination group has become or is about to become unavailable to the UE, a scheduled transitioning event, an indication that the UE has entered or is about to enter a specified geographical area, an indication that one or more signals from the second sidelink coordination group are received with a higher signal strength or other signal quality indicator than one or more signals received from the first sidelink coordination group, an indication that one or more sidelink resources of the first sidelink coordination group have become or are about to become unavailable to the UE, or any combination thereof.

Clause 61. The UE of clause 60, wherein: the second sidelink coordination group includes at least one sidelink user equipment (UE) that is not included in the first sidelink coordination group; the second sidelink coordination group includes fewer sidelink UEs than included in the first sidelink coordination group; the second sidelink coordination group includes at least one sidelink UE that is included in the first sidelink coordination group; the second sidelink coordination group uses a second synchronization sidelink UE that is different from a first synchronization sidelink UE used in the first sidelink coordination group; or any combination thereof.

Clause 62. The UE of any of clauses 45 to 61, further comprising: means for sending, to a location server, an indication of one or more preferred sidelink devices for use in one or more sidelink coordination groups.

Clause 63. A location server, comprising: means for receiving, from a user equipment (UE), an indication of one or more preferred sidelink devices with which the UE can communicate; and means for sending, to the UE, an indication of one or more sidelink coordination groups for positioning pre-configuration by the UE, wherein the one or more sidelink coordination groups include at least one of the one or more preferred sidelink devices.

Clause 64. The location server of clause 63, further comprising: means for sending, to the UE, an indication of one or more triggering events to be used by the UE to initiate a transition from positioning based on a first positioning synchronization source to positioning with a first sidelink coordination group of the one or more sidelink coordination groups.

Clause 65. The location server of any of clauses 63 to 64, wherein: means for receiving, from the UE, an indication of one or more preferred sidelink resources for inclusion in the one or more sidelink coordination groups.

Clause 66. The location server of any of clauses 64 to 65, wherein: the one or more triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the UE has entered or is about to enter an area in which the UE is likely to lose communication with the GNSS, an indication that the UE has entered or is about to enter a specified geographical area, an indication that a first positioning synchronization source currently used by the UE for positioning has become or is about to become unavailable to the UE, an indication that one or more signals from a first sidelink coordination group are received with a higher signal strength or other signal quality indicator than one or more signals received from a second sidelink coordination group, a scheduled transitioning event, an indication received from the location server that a positioning synchronization source transitioning event has occurred or is about to occur, or any combination thereof.

Clause 67. A non-transitory computer-readable medium storing computer-executable instructions that, when executed by a user equipment (UE), cause the UE to: determine a position of the UE based on a first positioning synchronization source; pre-configure a first sidelink coordination group for use by the UE prior to an occurrence of one or more first triggering events, wherein the first sidelink coordination group uses a second positioning synchronization source that is different than the first positioning synchronization source; and transition to use of the first sidelink coordination group for determining the position of the UE in response to the occurrence of the one or more first triggering events.

Clause 68. The non-transitory computer-readable medium of clause 67, wherein: the first positioning synchronization source is at least one of a base station or a Global Navigation Satellite System (GNSS).

Clause 69. The non-transitory computer-readable medium of any of clauses 67 to 68, wherein: the position of the UE using the first positioning synchronization source is determined in a UE-assisted positioning mode.

Clause 70. The non-transitory computer-readable medium of clause 69, wherein: the position of the UE using the first sidelink coordination group is determined in a UE-based positioning mode.

Clause 71. The non-transitory computer-readable medium of any of clauses 67 to 70, wherein: the one or more first triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the first positioning synchronization source has become or is about to become unavailable to the UE, an indication that one or more signals from the first sidelink coordination group are received with a higher signal strength or other signal quality indicator than one or more signals received from the first positioning synchronization source, an indication that the UE has entered or is about to enter an area in which the UE is likely to lose communication with the GNSS, an indication that the UE has entered or is about to enter a specified geographical area, a scheduled transitioning event, an indication received from a location server that a positioning synchronization source transitioning event has occurred or is about to occur, or any combination thereof.

Clause 72. The non-transitory computer-readable medium of any of clauses 67 to 71, further comprising computer-executable instructions that, when executed by the UE, cause the UE to: send one or more positioning capabilities of the UE to a location server.

Clause 73. The non-transitory computer-readable medium of any of clauses 67 to 72, further comprising computer-executable instructions that, when executed by the UE, cause the UE to: determine a recommended triggering event for transitioning to use of the first sidelink coordination group; and send an indication of the recommended triggering event to a location server.

Clause 74. The non-transitory computer-readable medium of any of clauses 67 to 73, further comprising computer-executable instructions that, when executed by the UE, cause the UE to: determine the position of the UE based on the first positioning synchronization source while monitoring sidelink resources of the first sidelink coordination group to pre-configure the first sidelink coordination group.

Clause 75. The non-transitory computer-readable medium of any of clauses 67 to 74, further comprising computer-executable instructions that, when executed by the UE, cause the UE to: send, to a location server, an indication of one or more preferred sidelink devices for use in the first sidelink coordination group.

Clause 76. The non-transitory computer-readable medium of any of clauses 67 to 75, further comprising computer-executable instructions that, when executed by the UE, cause the UE to: receive, from a location server, an indication of sidelink resources for the first sidelink coordination group.

Clause 77. The non-transitory computer-readable medium of any of clauses 67 to 76, further comprising computer-executable instructions that, when executed by the UE, cause the UE to: determine the first sidelink coordination group at the UE; and send an indication of the first sidelink coordination group to a location server.

Clause 78. The non-transitory computer-readable medium of clause 77, further comprising computer-executable instructions that, when executed by the UE, cause the UE to: pre-configure the first sidelink coordination group based, at least in part, on sidelink discovery operations conducted by the UE.

Clause 79. The non-transitory computer-readable medium of any of clauses 67 to 78, further comprising computer-executable instructions that, when executed by the UE, cause the UE to: pre-configure sidelink resources of a second sidelink coordination group.

Clause 80. The non-transitory computer-readable medium of clause 79, further comprising computer-executable instructions that, when executed by the UE, cause the UE to: use the first sidelink coordination group for positioning while monitoring sidelink resources of the second sidelink coordination group.

Clause 81. The non-transitory computer-readable medium of any of clauses 67 to 80, further comprising computer-executable instructions that, when executed by the UE, cause the UE to: determine that one or more second triggering events have occurred; and transition to use of a second sidelink coordination group for determining the position of the UE in response to a determination that the one or more second triggering events have occurred, wherein the second sidelink coordination group is pre-configured at the UE prior to the occurrence of the one or more second triggering events.

Clause 82. The non-transitory computer-readable medium of clause 81, wherein: the one or more second triggering events include an indication that the UE has lost or is about to lose communication with a positioning synchronization source of the first sidelink coordination group, an indication that the UE has entered or is about to enter an area in which the UE is likely to lose communication with one or more sidelink resources of the first sidelink coordination group, an indication that a positioning synchronization source used by the first sidelink coordination group has become or is about to become unavailable to the UE, a scheduled transitioning event, an indication that the UE has entered or is about to enter a specified geographical area, an indication that one or more signals from the second sidelink coordination group are received with a higher signal strength or other signal quality indicator than one or more signals received from the first sidelink coordination group, an indication that one or more sidelink resources of the first sidelink coordination group have become or are about to become unavailable to the UE, or any combination thereof.

Clause 83. The non-transitory computer-readable medium of clause 82, wherein: the second sidelink coordination group includes at least one sidelink user equipment (UE) that is not included in the first sidelink coordination group; the second sidelink coordination group includes fewer sidelink UEs than included in the first sidelink coordination group; the second sidelink coordination group includes at least one sidelink UE that is included in the first sidelink coordination group; the second sidelink coordination group uses a second synchronization sidelink UE that is different from a first synchronization sidelink UE used in the first sidelink coordination group; or any combination thereof.

Clause 84. The non-transitory computer-readable medium of any of clauses 67 to 83, further comprising computer-executable instructions that, when executed by the UE, cause the UE to: send, to a location server, an indication of one or more preferred sidelink devices for use in one or more sidelink coordination groups.

Clause 85. A non-transitory computer-readable medium storing computer-executable instructions that, when executed by a location server, cause the location server to: receive, from a user equipment (UE), an indication of one or more preferred sidelink devices with which the UE can communicate; and send, to the UE, an indication of one or more sidelink coordination groups for positioning pre-configuration by the UE, wherein the one or more sidelink coordination groups include at least one of the one or more preferred sidelink devices.

Clause 86. The non-transitory computer-readable medium of clause 85, further comprising computer-executable instructions that, when executed by the location server, cause the location server to: send, to the UE, an indication of one or more triggering events to be used by the UE to initiate a transition from positioning based on a first positioning synchronization source to positioning with a first sidelink coordination group of the one or more sidelink coordination groups.

Clause 87. The non-transitory computer-readable medium of any of clauses 85 to 86, further comprising computer-executable instructions that, when executed by the location server, cause the location server to: receive, from the UE, an indication of one or more preferred sidelink resources for inclusion in the one or more sidelink coordination groups.

Clause 88. The non-transitory computer-readable medium of any of clauses 86 to 87, wherein: the one or more triggering events include an indication that the UE has lost or is about to lose communication with a serving cell, an indication that the UE has entered or is about to enter an area in which the UE is likely to lose communication with the serving cell, an indication that the UE has lost or is about to lose communication with a global navigation satellite system (GNSS), an indication that the UE has entered or is about to enter an area in which the UE is likely to lose communication with the GNSS, an indication that the UE has entered or is about to enter a specified geographical area, an indication that a first positioning synchronization source currently used by the UE for positioning has become or is about to become unavailable to the UE, an indication that one or more signals from a first sidelink coordination group are received with a higher signal strength or other signal quality indicator than one or more signals received from a second sidelink coordination group, a scheduled transitioning event, an indication received from the location server that a positioning synchronization source transitioning event has occurred or is about to occur, or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM. CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a user equipment (UE), comprising:
determining a position of the UE based on a first positioning synchronization source;
pre-configuring a first sidelink coordination group for use by the UE prior to an occurrence of one or more first triggering events, wherein the first sidelink coordination group uses a second positioning synchronization source that is different than the first positioning synchronization source; and
in response to a determination that the one or more first triggering events has occurred, transitioning to use of the first sidelink coordination group for determining the position of the UE.

2. The method of claim 1, wherein:
the first positioning synchronization source is at least one of a base station or a Global Navigation Satellite System (GNSS).

3. The method of claim 1, wherein:
the position of the UE using the first positioning synchronization source is determined in a UE-assisted positioning mode.

4. The method of claim 3, wherein:
the position of the UE using the first sidelink coordination group is determined in a UE-based positioning mode.

5. The method of claim 1, wherein:
the one or more first triggering events include
an indication that the UE has lost or is about to lose communication with a serving cell,
an indication that the UE has entered or is about to enter an area in which the UE is likely to lose communication with the serving cell,
an indication that the UE has lost or is about to lose communication with a global navigation satellite system (GNSS),
an indication that the first positioning synchronization source has become or is about to become unavailable to the UE,
an indication that one or more signals from the first sidelink coordination group are received with a higher signal strength or other signal quality indicator than one or more signals received from the first positioning synchronization source,
an indication that the UE has entered or is about to enter an area in which the UE is likely to lose communication with the GNSS,
an indication that the UE has entered or is about to enter a specified geographical area,
a scheduled transitioning event,
an indication received from a location server that a positioning synchronization source transitioning event has occurred or is about to occur, or
any combination thereof.

6. The method of claim 1, further comprising:
sending one or more positioning capabilities of the UE to a location server.

7. The method of claim 1, further comprising:
determining, by the UE, a recommended triggering event for transitioning to use of the first sidelink coordination group; and
sending an indication of the recommended triggering event to a location server.

8. The method of claim 1, further comprising:
determining the position of the UE based on the first positioning synchronization source while monitoring sidelink resources of the first sidelink coordination group to pre-configure the first sidelink coordination group.

9. The method of claim 1, further comprising:
sending, to a location server, an indication of one or more preferred sidelink devices for use in the first sidelink coordination group.

10. The method of claim 1, further comprising:
receiving, from a location server, an indication of sidelink resources for the first sidelink coordination group.

11. The method of claim 1, further comprising:
determining the first sidelink coordination group at the UE; and
sending an indication of the first sidelink coordination group to a location server.

12. The method of claim 11, further comprising:
pre-configuring the first sidelink coordination group based, at least in part, on sidelink discovery operations conducted by the UE.

13. The method of claim 1, further comprising:
pre-configuring sidelink resources of a second sidelink coordination group.

14. The method of claim 13, further comprising:
using the first sidelink coordination group for positioning while monitoring sidelink resources of the second sidelink coordination group.

15. The method of claim 1, further comprising:
determining that one or more second triggering events have occurred; and
in response to a determination that the one or more second triggering events have occurred, transitioning to use of a second sidelink coordination group for determining the position of the UE, wherein the second sidelink coordination group is pre-configured at the UE prior to the occurrence of the one or more second triggering events.

16. The method of claim 15, wherein:
the one or more second triggering events include
an indication that the UE has lost or is about to lose communication with a positioning synchronization source of the first sidelink coordination group,
an indication that the UE has entered or is about to enter an area in which the UE is likely to lose communication with one or more sidelink resources of the first sidelink coordination group,
an indication that a positioning synchronization source used by the first sidelink coordination group has become or is about to become unavailable to the UE,
a scheduled transitioning event,
an indication that the UE has entered or is about to enter a specified geographical area,
an indication that one or more signals from the second sidelink coordination group are received with a higher signal strength or other signal quality indicator than one or more signals received from the first sidelink coordination group,
an indication that one or more sidelink resources of the first sidelink coordination group have become or are about to become unavailable to the UE, or
any combination thereof.

17. The method of claim 16, wherein:
the second sidelink coordination group includes at least one sidelink user equipment (UE) that is not included in the first sidelink coordination group;
the second sidelink coordination group includes fewer sidelink UEs than included in the first sidelink coordination group;
the second sidelink coordination group includes at least one sidelink UE that is included in the first sidelink coordination group;
the second sidelink coordination group uses a second synchronization sidelink UE that is different from a first synchronization sidelink UE used in the first sidelink coordination group; or
any combination thereof.

18. The method of claim 1, further comprising:
sending, to a location server, an indication of one or more preferred sidelink devices for use in one or more sidelink coordination groups.

19. A method of wireless communication performed by a location server, comprising:
receiving, from a user equipment (UE), an indication of one or more preferred sidelink devices with which the UE can communicate; and
sending, to the UE, an indication of one or more sidelink coordination groups for positioning pre-configuration by the UE, wherein the one or more sidelink coordination groups include at least one of the one or more preferred sidelink devices.

20. The method of claim 19, further comprising:
sending, to the UE, an indication of one or more triggering events to be used by the UE to initiate a transition from positioning based on a first positioning synchronization source to positioning with a first sidelink coordination group of the one or more sidelink coordination groups.

21. The method of claim 19, wherein:
receiving, from the UE, an indication of one or more preferred sidelink resources for inclusion in the one or more sidelink coordination groups.

22. The method of claim 19, wherein:
the one or more triggering events include
an indication that the UE has lost or is about to lose communication with a serving cell,
an indication that the UE has entered or is about to enter an area in which the UE is likely to lose communication with the serving cell,
an indication that the UE has lost or is about to lose communication with a global navigation satellite system (GNSS),
an indication that the UE has entered or is about to enter an area in which the UE is likely to lose communication with the GNSS,
an indication that the UE has entered or is about to enter a specified geographical area,
an indication that a first positioning synchronization source currently used by the UE for positioning has become or is about to become unavailable to the UE,
an indication that one or more signals from a first sidelink coordination group are received with a higher signal strength or other signal quality indicator than one or more signals received from a second sidelink coordination group,
a scheduled transitioning event,
an indication received from the location server that a positioning synchronization source transitioning event has occurred or is about to occur, or
any combination thereof.

23. A user equipment (UE), comprising:
a memory;
at least one transceiver; and
at least one processor communicatively coupled to the memory and the at least one transceiver, the at least one processor configured to:
determine a position of the UE based on a first positioning synchronization source;
pre-configure a first sidelink coordination group for use by the UE prior to an occurrence of one or more first triggering events, wherein the first sidelink coordination group uses a second positioning synchronization source that is different than the first positioning synchronization source; and
in response to a determination that the one or more first triggering events has occurred, transition to use of the first sidelink coordination group for determining the position of the UE.

24. The UE of claim 23, wherein:
the first positioning synchronization source is at least one of a base station or a Global Navigation Satellite System (GNSS).

25. The UE of claim 23, wherein:
the position of the UE using the first positioning synchronization source is determined in a UE-assisted positioning mode.

26. The UE of claim 25, wherein:
the position of the UE using the first sidelink coordination group is determined in a UE-based positioning mode.

27. The UE of claim 23, wherein:
the one or more first triggering events include
an indication that the UE has lost or is about to lose communication with a serving cell,
an indication that the UE has entered or is about to enter an area in which the UE is likely to lose communication with the serving cell,
an indication that the UE has lost or is about to lose communication with a global navigation satellite system (GNSS),
an indication that the first positioning synchronization source has become or is about to become unavailable to the UE,
an indication that one or more signals from the first sidelink coordination group are received with a higher signal strength or other signal quality indicator than one or more signals received from the first positioning synchronization source,
an indication that the UE has entered or is about to enter an area in which the UE is likely to lose communication with the GNSS,
an indication that the UE has entered or is about to enter a specified geographical area,
a scheduled transitioning event,
an indication received from a location server that a positioning synchronization source transitioning event has occurred or is about to occur, or
any combination thereof.

28. The UE of claim 23, wherein the at least one processor is further configured to:
determine the position of the UE based on the first positioning synchronization source while monitoring sidelink resources of the first sidelink coordination group to pre-configure the first sidelink coordination group.

29. A location server, comprising:
a memory;
at least one transceiver; and
at least one processor communicatively coupled to the memory and the at least one transceiver, the at least one processor configured to:
receive, via the at least one transceiver, from a user equipment (UE), an indication of one or more preferred sidelink devices with which the UE can communicate; and
send, via the at least one transceiver, to the UE, an indication of one or more sidelink coordination groups for positioning pre-configuration by the UE, wherein the one or more sidelink coordination groups include at least one of the one or more preferred sidelink devices.

30. The location server of claim 29, wherein the at least one processor is further configured to:
send, via the at least one transceiver, to the UE, an indication of one or more triggering events to be used by the UE to initiate a transition from positioning based on a first positioning synchronization source to positioning with a first sidelink coordination group of the one or more sidelink coordination groups.
